(19) United States
(12) Patent Application Publication
(10) Pub. No.: US 2014/0165011 A1
(43) Pub. Date: Jun. 12, 2014

(54) INFORMATION PROCESSING APPARATUS

(71) Applicant: CANON KABUSHIKI KAISHA, Tokyo (JP)

(72) Inventor: Junichi Goda, Kawasaki-shi (JP)

(73) Assignee: CANON KABUSHIKI KAISHA, Tokyo (JP)

(21) Appl. No.: 14/081,151

(22) Filed: Nov. 15, 2013

(30) Foreign Application Priority Data
Dec. 10, 2012 (JP) 2012-269782

(51) Int. Cl. G06F 3/0484; G06F 3/0488

(52) U.S. Cl. CPC G06F 3/04842; G06F 3/0488
USPC 715/853

(57) ABSTRACT

When a plurality of images are laid out within one page, the images may overlap each other. There is provided a layer change unit configured to, if the images overlap each other, intuitively change the hierarchical level of an image to perform processing for an image hidden behind another image, thereby allowing processing for the image hidden behind the other image by changing the hierarchical level of the image while maintaining its position without moving the image.

### BACKGROUND OF THE INVENTION

1. Field of the Invention

The present invention relates to, for example, a technique of laying out a plurality of images displayed on a display unit and, more particularly, to an information processing apparatus.

2. Description of the Related Art

Conventionally, an information processing apparatus such as a portable terminal accepts processing designated by a user operation through an operation unit including a touch panel (touch screen). An information processing apparatus including a touch panel allows a flick input operation of detecting touch coordinates on the touch panel and the locus of a slide operation to input data. In recent years, some information processing apparatuses include a multi-touch sensor capable of simultaneously detecting touch coordinates by a plurality of fingers and the loci of them, that is, touches at a plurality of positions. The user can execute operations assigned, in advance, to variations of the number of points of touches and the locus of a flick operation by the multi-touch sensor, resulting in an increase in operability.

When performing, for example, a layout operation on a screen on which a plurality of images are displayed using such high operability, the user can select an image, and move, enlarge/reduce, or rotate the selected image. The layout operation is an operation of arranging the plurality of images with desired sizes at desired positions within one page. During the layout operation, the plurality of images may overlap each other. If the images overlap each other, it is difficult to select an image hidden or occluded behind another image.

To solve this problem, there is proposed the following technique (Japanese Patent Laid-Open No. 2010-140417). That is, a touch sensor is provided on each of the front and rear surfaces of a device, and a pressure sensor is also provided on the rear surface. According to the position and pressure of a finger with which the user presses the rear surface, an image arranged on the front side is moved, thereby enabling selection of an image hidden by the other image.

Although it is possible to select the image hidden behind another image by moving the image on the front of the hidden image, the position of the image arranged according to the original desired layout changes. Therefore, after performing processing for the image hidden behind another image, it is necessary to perform layout processing again for the image which was laid out before, for example, it is necessary to return the moved image on the front of the hidden image to the original position, thereby impairing the user convenience.

### SUMMARY OF THE INVENTION

The present invention has been made in consideration of the aforementioned conventional example, and provides an information processing apparatus and an information processing method, which allow an operation for a desired image while maintaining the layout by providing, for a selected image, an operation of lowering the hierarchical level of the image.

According to the first aspect, the present invention has the following arrangement.

An information processing apparatus comprises: a display unit configured to display an image; a coordinate input unit having a coordinate system common to a display surface of the display unit; a holding unit configured to hold hierarchical levels of image objects displayed by the display unit; and a layer change unit configured to update the hierarchical levels held in the holding unit so as to lower the hierarchical level of a designated image object according to an operation via the coordinate input unit, wherein the display unit displays the image objects according to the hierarchical levels updated by the layer change unit.

Alternatively, according to another aspect, the present invention has the following arrangement.

An information processing apparatus comprises: a display unit configured to display an image; an input unit configured to perform an input operation according to a user operation; a holding unit configured to hold hierarchical levels of image objects displayed by the display unit; and a layer change unit configured to update the hierarchical levels held in the holding unit so as to raise the hierarchical level of an image object having a lowest hierarchical level among overlapping image objects to a highest one of hierarchical levels of the overlapping image objects, wherein the display unit displays the image objects according to the hierarchical levels updated by the layer change unit.

Or, according to still another aspect, the present invention has the following arrangement.

An information processing apparatus comprises: a first touch screen for displaying a plurality of image objects; a second touch screen; a specification unit configured to specify one of the plurality image objects displayed on the first touch screen in response to a user touch operation via the first touch screen; and a processing unit configured to perform a predetermined process on the specified image object in response to a user touch operation via the second touch screen.

According to the present invention, it is possible to change the hierarchical level (layer) of an image without moving its position. This enables selection and processing of an image hidden behind another image while maintaining the positions of already laid out images, thereby improving the user convenience. The present invention is effective especially for performing layout processing for a plurality of images.

Further features of the present invention will become apparent from the following description of exemplary embodiments with reference to the attached drawings.

### BRIEF DESCRIPTION OF THE DRAWINGS

FIG. 1 is a view showing the outer appearance of an information processing apparatus;

FIG. 2 is a block diagram showing an example of the hardware arrangement of the information processing apparatus;

FIG. 3 is a table showing an image management table 300;

FIG. 4 is a view showing a case in which a plurality of images are displayed on a liquid crystal display 1009;

FIG. 5 is a flowchart illustrating a processing procedure when a first touch panel operation is detected;

FIGS. 6A to 6D are views each showing the state of the liquid crystal display 1009 and the image management table 300 when the first touch panel operation is detected;

FIG. 7 is a flowchart illustrating a layer movement processing procedure;

FIG. 8 is a flowchart illustrating a layer movement unit;

FIG. 9 is a flowchart for explaining a method of updating layer information 302 of the image management table 300;

FIGS. 10A to 10D are views each showing the state of the liquid crystal display 1009 and the image management table 300 when the layer movement unit is in a mode in which a selected image is moved to the most foreground or background level;

FIGS. 11A to 11F are views each showing the state of the liquid crystal display 1009 and the image management table 300 when the layer movement unit is in a mode in which the layer of a selected image is moved by one hierarchical level;

FIGS. 12A to 12C are views each showing the state of the liquid crystal display 1009 and the image management table 300 when the layer movement unit is in a mode in which the layer of a selected image is moved according to the number of fingers with which a double tap is performed;

FIGS. 13A and 13B are views each showing the state of the liquid crystal display 1009 and the image management table 300 when a plurality of images are selected;

FIG. 14 is a flowchart illustrating a processing procedure of lowering the hierarchical level of an image according to a tap position;

FIGS. 15A and 15B are views each showing the state of the liquid crystal display 1009 and the image management table 300 when processing of lowering the hierarchical level of an image according to a tap position is executed;

FIG. 16 is a table showing an overlapping image layer management table 500;

FIGS. 17A and 17B are views each showing the state of the liquid crystal display 1009 when a plurality of images overlap each other;

FIG. 18 is a table showing a given state of the image management table 300;

FIG. 19 is a flowchart illustrating a processing procedure of moving an image hidden behind another image to the foreground of the liquid crystal display 1009;

FIG. 20 is a flowchart illustrating layer change processing;

FIGS. 21A to 21F are views showing a method of updating and controlling the image management table 300 and the overlapping image layer management table 500 when a second touch panel 1008 is double tapped; and

FIGS. 22A to 22E are views showing a method of updating and controlling the image management table 300 and the overlapping image layer management table 500 when the second touch panel 1008 is double tapped.

### DESCRIPTION OF THE EMBODIMENTS

### First Embodiment

The first embodiment for implementing the present invention will be described below with reference to the accompanying drawings.

<Appearance of Information Processing Apparatus>

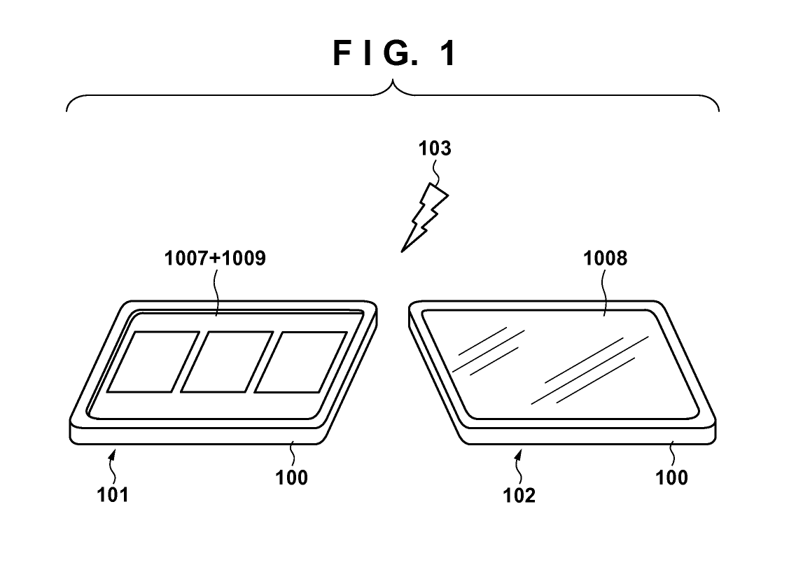

FIG. 1 is a view showing the outer appearance of an information processing apparatus according to this embodiment. An information processing apparatus 100 indicates a portable information terminal such as a smartphone or a portable information processing apparatus such as a tablet. The information processing apparatus 100 may be an operation unit detachable to a multi-function peripheral (not shown). The information processing apparatus 100 can exchange document data and image data with the Internet via a wireless line 103, and communicate with a multi-function peripheral or storage device (neither of which are shown). A front surface portion 101 of the information processing apparatus 100 has a two-layer structure including a first touch panel 1007 made of a transparent material and a liquid crystal display 1009 under the first touch panel 1007. A rear surface portion 102 of the information processing apparatus 100 includes a second touch panel 1008. The second touch panel is arranged to face the first touch panel on its rear side. The information processing apparatus 100 receives a user operation from the first touch panel 1007 or the second touch panel 1008.

Operations on the first touch panel 1007 and the second touch panel 1008 are independent of each other, and can be individually assigned with processes such as operation mode selection processing, processing of setting various functions, and operation instruction processing. The first touch panel 1007 allows layout processing such as enlargement/reduction or movement of an image displayed on the liquid crystal display 1009 by a tap, drag, pinch, or flick operation.

For explanation of the embodiment, characteristic processes assigned to the first touch panel 1007 and the second touch panel 1008 will be described. When it is detected that the user has single tapped the first touch panel 1007, selection/cancelation processing is performed for an image displayed on the liquid crystal display 1009. The single tap indicates an operation of touching the first touch panel 1007 with a finger for a given short time, and immediately releasing the finger. The selection/cancelation processing indicates an operation of tapping an unselected image to enter a selected state or tapping a selected image to cancel the selection.

When it is detected that the user has double tapped at least one of the first touch panel 1007 and the second touch panel 1008, layer change processing is performed for an image displayed on the liquid crystal display 1009. Note that the double tap indicates processing of touching the first touch panel 1007 or the second touch panel 1008 with a finger twice within a given short time. A detailed description thereof will be provided later.

<Hardware Arrangement of Information Processing Apparatus>

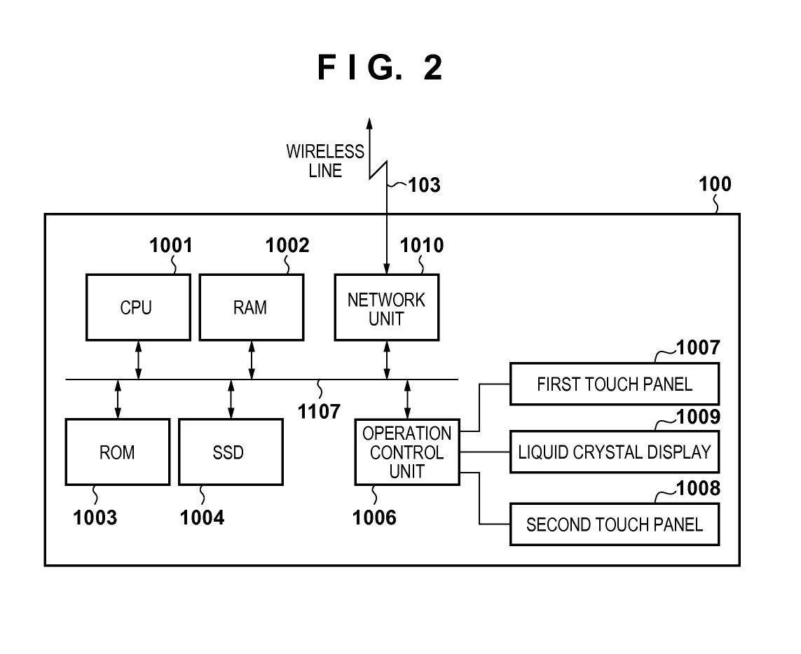

FIG. 2 is a block diagram showing details of an example of the hardware arrangement of the information processing apparatus according to the embodiment.

The information processing apparatus 100 includes a CPU 1001, a RAM 1002, a ROM 1003, an SSD 1004, an operation control unit 1006, and a network unit 1010, which are interconnected by a system bus 1107. The information processing apparatus 100 also includes the first touch panel 1007, the second touch panel 1008, and the liquid crystal display 1009, which are connected to the operation control unit 1006.

The first touch panel 1007 is formed by a touch panel of an electrostatic capacitance type capable of detecting a multi-touch operation for an operation input by the user. The second touch panel 1008 serves as a second input unit formed by a touch panel capable of detecting a multi-touch operation like the first touch panel 1007.

The CPU 1001 centrally controls various processes executed within the information processing apparatus 100. The RAM 1002 serves as a system work memory for the operation of the CPU 1001, and also serves as an image memory for temporarily storing image data and the like. The RAM 1002 is a boot ROM, and stores the boot program of a system. The SSD 1004 is a solid-state drive, and mainly stores image data and information (system software) necessary for starting/operating a computer. Furthermore, the SSD 1004 stores programs for causing the CPU 1001 to execute flowcharts (to be described below). These data need not be stored in the SSD 1004, and may be stored in a recording medium which can store data even after the power is turned off. The network unit 1010 is connected to the wireless line 103 to perform communication (transmission/reception) with the Internet or an external device such as an image forming apparatus (not shown).

The first touch panel 1007, the second touch panel 1008, and the liquid crystal display 1009 are connected to the operation control unit 1006, and transmit/receive necessary data, information, and control signals, respectively. The liquid crystal display 1009 is arranged under the first touch panel 1007 to share a coordinate system with a display surface. An image displayed on the liquid crystal display 1009 can be seen from the outside through the first touch panel 1007.

The operation control unit 1006 notifies the CPU 1001 of position information indicating a touch position on the first touch panel 1007 or the second touch panel 1008. The CPU 1001 can identify an operation performed on the first touch panel 1007 or the second touch panel 1008 by the user by checking a touch position, as needed. Furthermore, the CPU 1001 can detect the number of fingers with which the user taps the first touch panel 1007 or the second touch panel 1008.

Based on the instruction of the CPU 1001, the operation control unit 1006 transmits a display target image to the liquid crystal display 1009. The CPU 1001 generates a display target image based on information of an image management table 300 (to be described later).

Note that even in the system according to the embodiment, an operating system (OS) for input/output control or resource management such as scheduling of processes is prepared, and an application such as an image layout application is implemented using a function provided by the OS. For example, the OS processes an operation on the touch panel, and an application can acquire, via an interface provided by the OS, information indicating whether the operation is a single tap, double tap, flick, or pinch, and information indicating a position where the operation is performed. The OS also sends information indicating whether the operated device is the first touch panel 1007 on the front side or the second touch panel 1008 on the rear side, as a matter of course.

This embodiment is effective for laying out a plurality of images. An example of a plurality of images displayed on the liquid crystal display 1009 and a method of managing the displayed images according to the embodiment will be described first, and then a detailed processing procedure will be explained.

<Image Management Table>

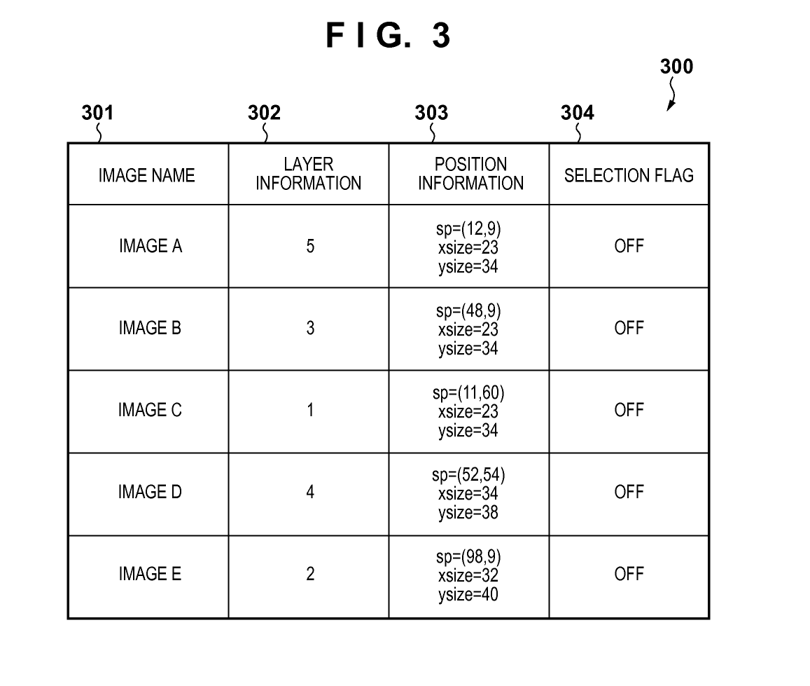

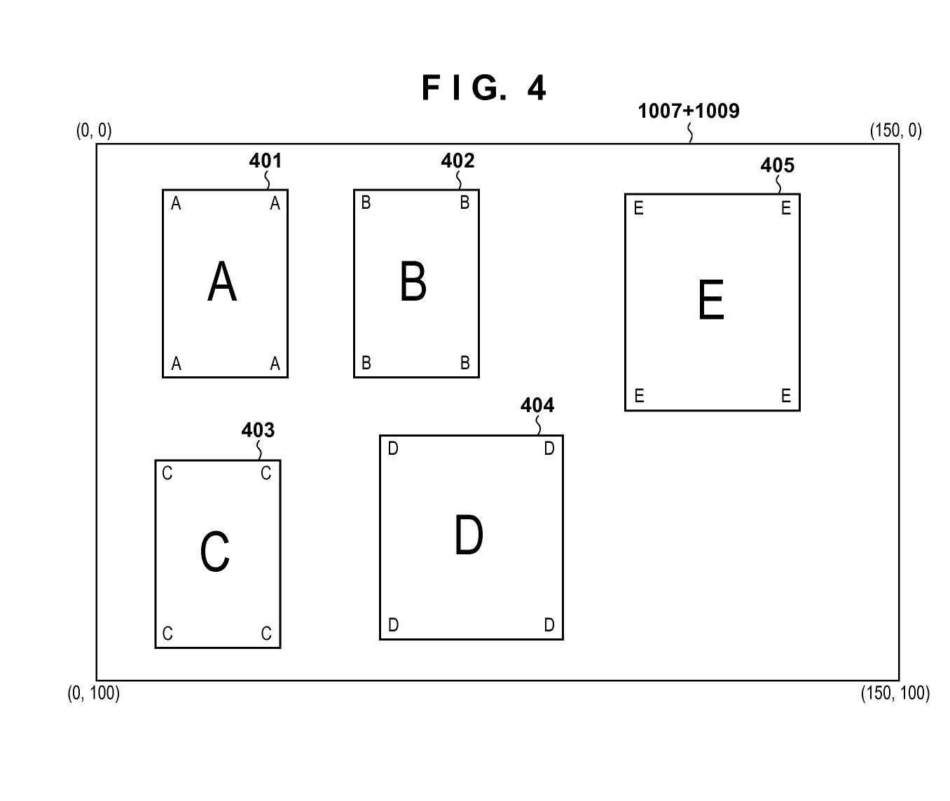

FIG. 3 is a table showing the image management table 300. The image management table 300 is a table necessary for realizing an operation of an image according to the embodiment, and is managed and updated by the CPU 1001. The image management table 300 will be described with reference to FIG. 4 showing a screen on which images registered in the image management table 300 shown in FIG. 3 are displayed. Note that an image stored in an SSD or the like should be called an “image object” or “image data” in terms of information processing. Since, however, image data and an image obtained by visually displaying the image data are inseparable, image data may be simply referred to as an image in this embodiment. Furthermore, since a screen formed by laying out individual images is also an image, the individual component images may be referred to as image objects in order to avoid confusion. In this example, image data is formed by, for example, full-color pixels, and is represented as a rectangular image in which pixels are arrayed in a grid pattern. Note that every time a new image to be laid out is selected and laid out, for example, an application for providing an image layout function adds a record associated with the image to the image management table shown in FIG. 3. The position information of the added record is updated according to the layout. As will be described later, the layer information of the record is also changed according to a layer movement operation, as a matter of course.

FIG. 4 is a view showing a case in which the plurality of images managed by the image management table 300 shown in FIG. 3 are displayed on the liquid crystal display 1009. Five images 401 to 405 are displayed on the liquid crystal display 1009.

Referring back to FIG. 3, the column of an image name 301 is used to manage the images displayed on the liquid crystal display 1009 by unique names. In the example shown in FIG. 3, the images displayed on the liquid crystal display 1009 are managed by setting image A as the image name of the image 401, image B as the image name of the image 402, image C as the image name of the image 403, image D as the image name of the image 404, and image E as the image name of the image 405. In the following description, the images 401 to 405 correspond to images A, B, C, D, and E, respectively.

The column of layer information 302 is used to indicate the hierarchical levels of the images displayed on the liquid crystal display 1009. The respective images are sequentially assigned with integer values from 1. A smaller integer value indicates a higher hierarchical level. In this example, the value of the layer information 302 of image C is “1” which indicates the highest hierarchical level, and the value of the layer information 302 of image A is “5” which indicates the lowest hierarchical level. The hierarchical level indicates the priority order of display. If an image of an upper layer overlaps an image of a lower layer, the image of the upper layer in the overlapping portion is displayed intact to hide the image of the lower layer. Note that in this example, one image belongs to each layer so the layers of two images always have a hierarchical relationship.

The column of position information 303 is used to indicate the positions of the images displayed on the liquid crystal display 1009. The position information is managed by three values: sp (start point) indicating the position of the upper left corner of each image on the liquid crystal display, xsize indicating the size of the image in the horizontal direction, and ysize indicating the size of the image in the vertical direction. In this example, the position of the upper left corner of the liquid crystal display 1009 shown in FIG. 3 is (0, 0), the position of its upper right corner is (150, 0), the position of its lower left corner is (0, 100), and the position of its lower right corner is (150, 100). That is, a position on the screen is indicated by a coordinate system having the upper left corner as an origin, an X-axis extending rightward, and a Y-axis extending downward. In this example, the value of sp of image A is (12, 9) which indicates that the upper left corner of image A is positioned at a position of “12” in the horizontal direction and “9” in the vertical direction from the upper left corner of the liquid crystal display 1009. Furthermore, the value of xsize is “23” and the value of ysize is “34”, which indicates that image A has a size of “23” in the horizontal direction and “34” in the vertical direction from the coordinates represented by sp.

The column of a selection flag 304 is used to indicate whether the images displayed on the liquid crystal display 1009 are currently selected. If a corresponding image is currently selected, the selection flag is ON; otherwise, the selection flag is OFF. ON/OFF of the selection flag 304 is switched when the first touch panel 1007 is pressed by a single tap, and the CPU 1001 updates the value of the selection flag 304 of an image corresponding to the pressed position. Selection of an image and its layer are independent of each other. Therefore, even if a given image is selected, its layer does not change by only the selection operation.

<Normal Operation Processing Procedure>

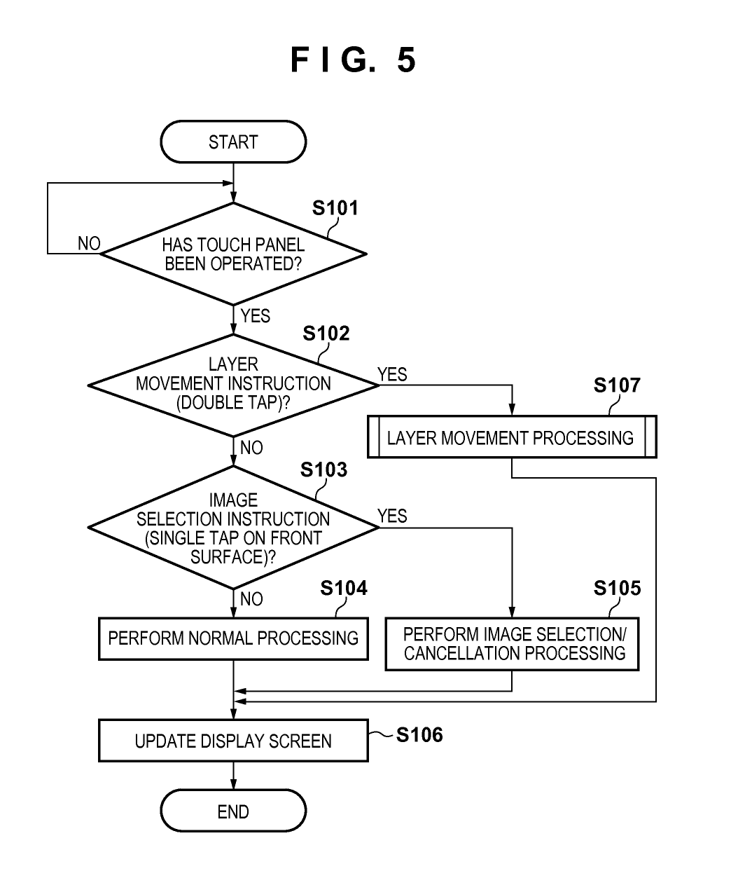

FIG. 5 is a flowchart illustrating a processing procedure when the user operates the first touch panel 1007 or the second touch panel 1008 according to the embodiment. In particular, assume that a plurality of images are displayed on the liquid crystal display 1009 and the user performs layout processing.

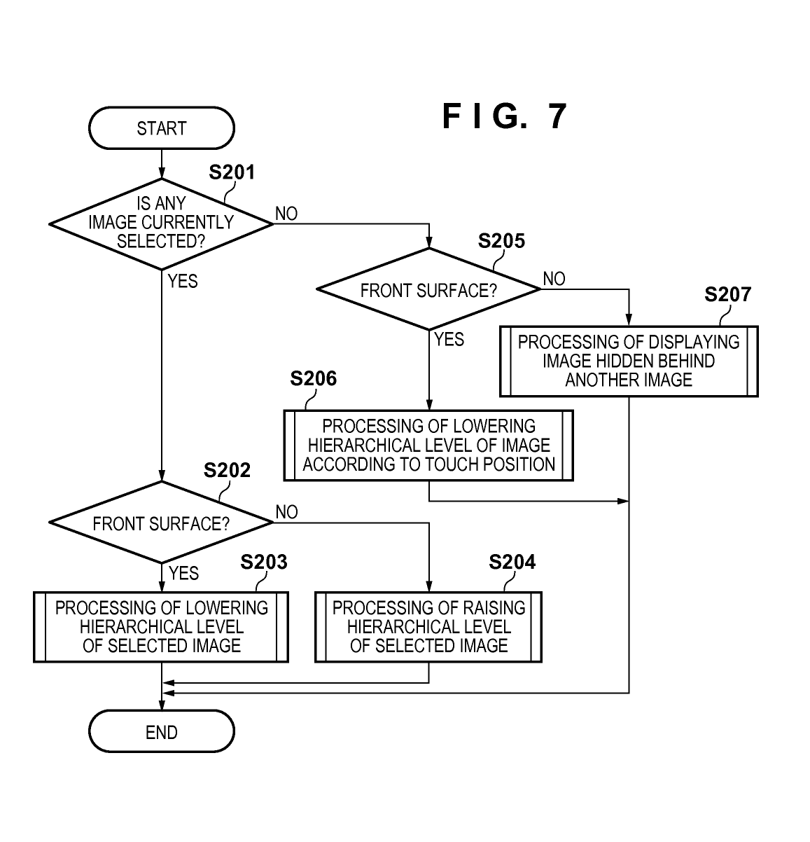

The flowchart shown in FIG. 5 is implemented when the CPU 1001 expands a program stored in the SSD 1004 onto the RAM 1002, and executes it. The CPU 1001 executes the processing procedure shown in FIG. 5 unless otherwise specified, and will thus be omitted in a description of the processing procedure. Similarly, the CPU 1001 executes all processing procedures (FIGS. 7, 8, 9, 14, 19, and 20) to be described later. These procedures are managed by the image management table 300, and executed for the images displayed on the liquid crystal display 1009.

During a layout edit operation, processing in steps S101 to S107 are repeatedly executed. In step S101, it is detected whether the user operates the first touch panel 1007 or the second touch panel 1008. If no operation is detected, the process stands by for detection of an operation. If an operation is detected, it is determined in step S102 whether the operation indicates a layer movement instruction. In this embodiment, a layer movement instruction corresponds to a double tap operation on the first touch panel 1007 or the second touch panel 1008.

If it is determined that the operation indicates a layer movement instruction, layer movement processing characteristic to the embodiment is executed in step S107. The layer movement processing is processing of controlling the value of the layer information 302 of the image management table 300. The processing procedure in step S107 will be described in detail later with reference to FIG. 7.

If it is determined in step S102 that the operation does not indicate a layer movement instruction, the process advances to step S103. In step S103, it is determined whether the operation indicates an image selection instruction. In this embodiment, an image selection instruction corresponds to a single tap operation on the first touch panel 1007. If it is determined that the operation indicates an image selection instruction, the value of the selection flag of the image management table 300 is updated in step S105. As an update method, if an image exists at the tap position, the selection flag 304 of the tapped image is inverted. If the state before the tap is OFF, the flag is turned on. On the other hand, if the state before the tap is ON, the flag is turned off. If there is no image at the tap position, the selection flags 304 of all the images registered in the image management table 300 are turned off. If a plurality of images overlap each other at the tap position, the states of the pieces of layer information 302 of the images are referred to, and image selection (or selection cancellation) processing is performed for the image positioned at the highest hierarchical level.

If it is determined in step S103 that the operation does not indicate an image selection instruction, normal processing is performed in step S104. In the normal processing, movement or enlargement/reduction processing is performed for an image if the image is currently selected, and movement or enlargement/reduction processing is performed for the screen displayed on the liquid crystal display 1009 if no image is currently selected. As a more specific internal operation, if an image is currently selected, for example, it is detected that the user has performed a flick or pinch operation on the first touch panel 1007, and size information and the position information 303 of the image management table 300 are updated according to the operation.

In step S106, according to the state of the image management table 300 updated in step S104, S105, or S107, the image is enlarged/reduced to a size designated by the position information 303 and arranged at a designated position, image data corresponding to the display screen of the liquid crystal display 1009 is generated, and then the image data of the whole screen to be displayed on the liquid crystal display 1009 is transmitted via the operation control unit 1006.

Note that a method of displaying data on the liquid crystal display 1009 if the normal processing in step S104 is an operation on a window will not be described in detail. The CPU 1001 also updates the position information 303 of the image management table 300 according to the state of the display window.

<State of Image Management Table and Liquid Crystal Display Image in Normal Operation Processing Procedure>

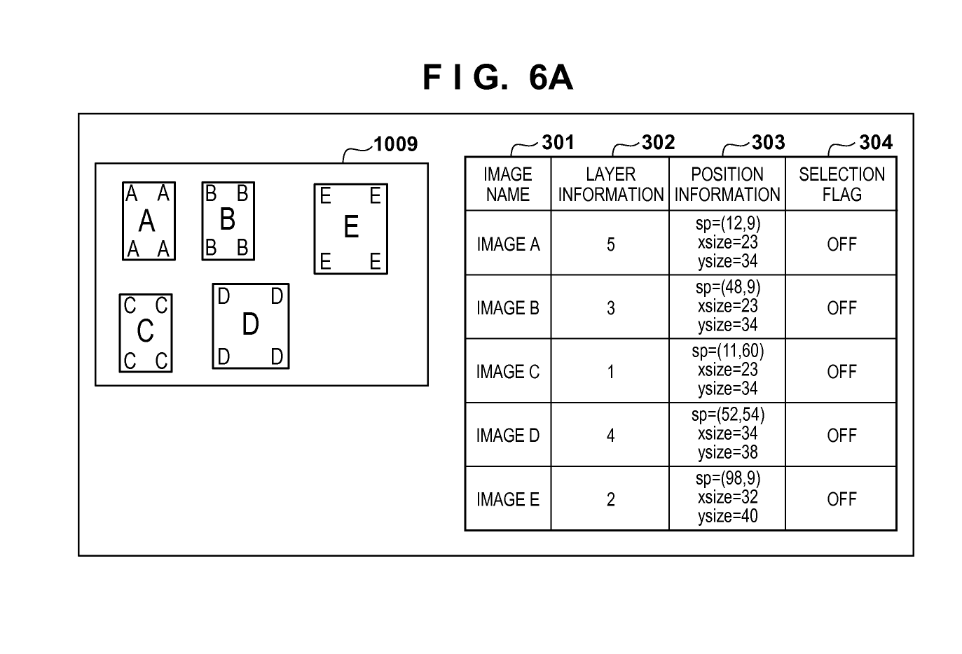

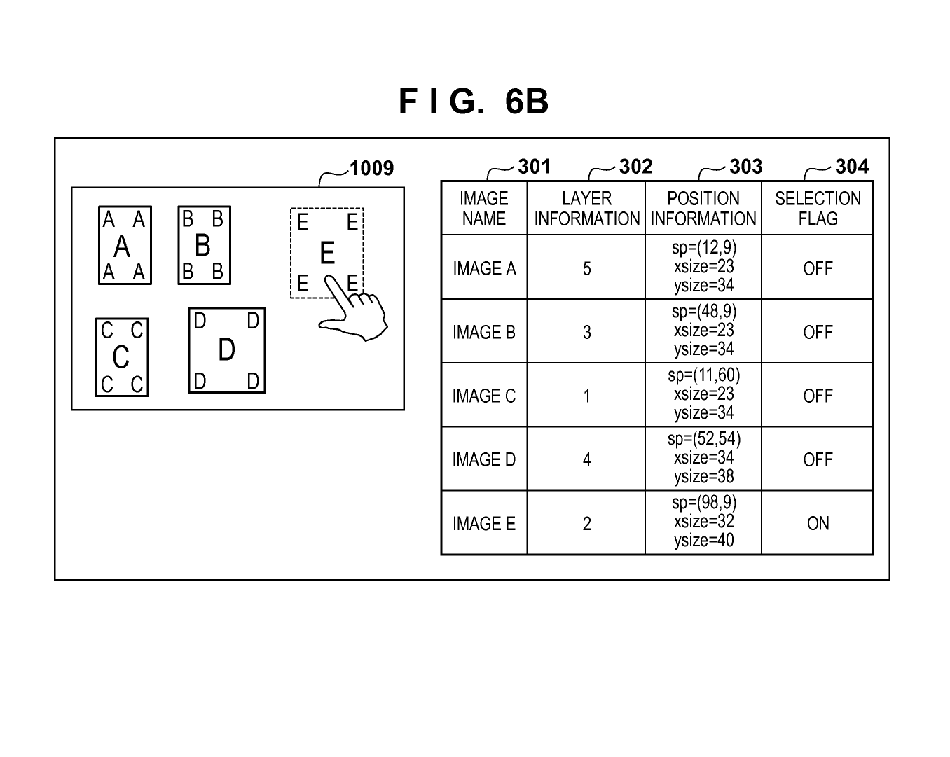

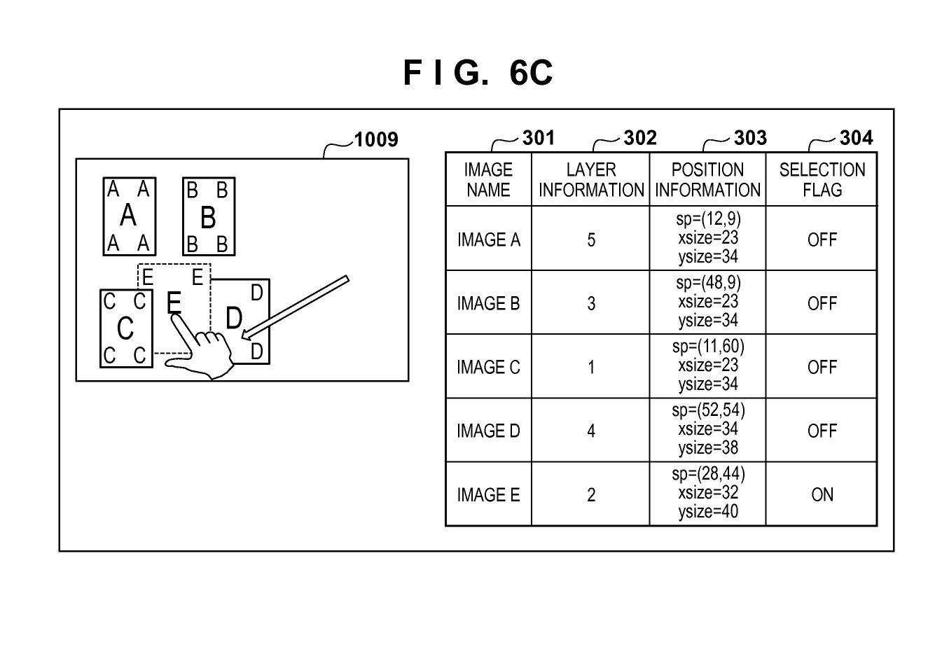

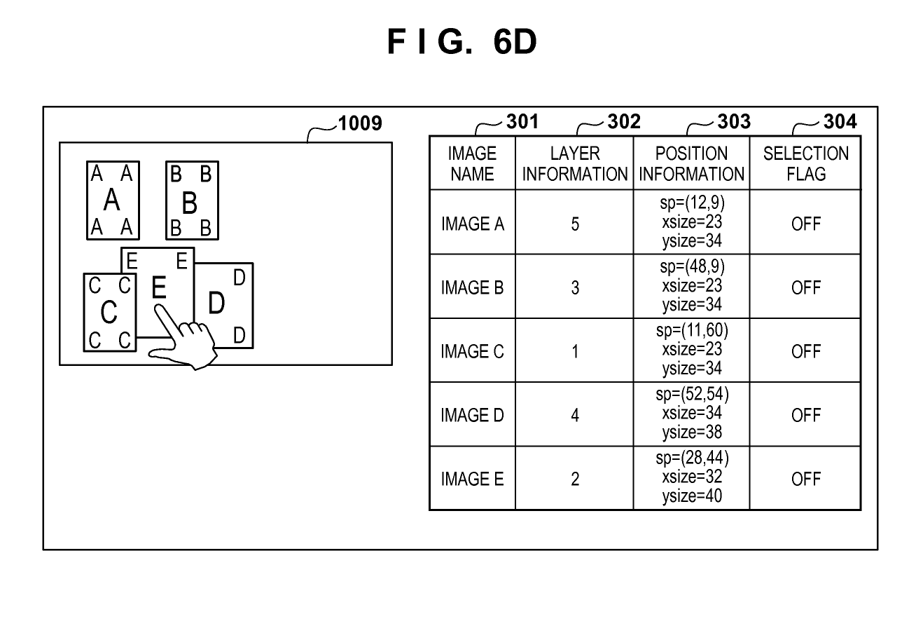

FIGS. 6A to 6D are views each showing a case in which the user operates the first touch panel 1007. More specifically, FIGS. 6A to 6D are views each showing the state when the processing in steps S101 to S106 of the flowchart shown in FIG. 5 is performed. Each of FIGS. 6A to 6D shows the state of the image management table 300 in the right portion and display of the liquid crystal display 1009 corresponding to the state in the left portion.

FIG. 6A is a view showing a given state of the layout of the five images. Referring to FIG. 6A, images A to E are displayed without overlapping each other, and none of images A to E is currently selected. A processing procedure when the user single taps the position of image E on the first touch panel 1007 to select image E in the state shown in FIG. 6A is as follows.

The CPU 1001 detects the operation of the first touch panel 1007 in step S101, determines in step S102 that the operation does not indicate layer movement processing, determines in step S103 that the operation indicates an image selection instruction, and performs image selection/cancellation processing in step S105. Since the state of the selection flag 304 of image E is OFF, the selection flag 304 is turned on. As a result, the state of the image management table 300 shown in FIG. 6B is obtained. After the image management table 300 is thus updated, the screen of the display 1009 shown in FIG. 6B is displayed in step S106. To identify the selected image, its frame is indicated by dotted lines.

A processing procedure when the user slides image E obliquely downward in the state shown in FIG. 6B is as follows.

The processes in steps S101 and S102 are the same as those described with reference to FIG. 6B. The CPU 1001 determines in step S103 that the operation does not indicate an image selection instruction, and performs the normal processing in step S104. In this case, the CPU 1001 detects that the user has slid his/her finger from the position of image E toward the lower left corner, and updates the position information 303 of image E according to a vector defined by the start and end points of the flick operation. As a result, the state of the image management table 300 shown in FIG. 6C is obtained. After the image management table 300 is thus updated, the screen of the display 1009 shown in FIG. 6C is displayed in step S106. In this state, images E overlaps images C and D. If images overlap each other, the CPU 1001 refers to the layer information 302 of each image in step S106, and sequentially displays the images to overlap each other from an image having a lower hierarchical level. In the example shown in FIG. 6C, the hierarchical level of image C is 1, that of image D is 4, and that of image E is 2. An image having a smaller value is positioned at an upper hierarchical level, and displayed over an image of a lower hierarchical level. As a result, images D, E, and C are displayed to overlap each other from the rear side in the order named.

A processing procedure when the user single taps the position of image E on the first touch panel 1007 to cancel the selection of the image in the state of FIG. 6C is as follows.

The processes in steps S101, S102, and S103 are the same as those described with reference to FIG. 6B. Since the state of the selection flag 304 of image E is ON, it is changed to an OFF state in step S105. As a result, the state of the image management table 300 shown in FIG. 6D is obtained. After the image management table 300 is thus updated, the screen of the display 1009 shown in FIG. 6D is displayed in step S106. In this state, the selection of image E is canceled and its frame returns from the dotted lines to the original ones.

In this embodiment, selection of an image on only the first touch panel 1007 has been described. This is because it is impossible to identify the position of a finger on the second touch panel 1008 arranged on the rear surface of the information processing apparatus 100, and it is thus difficult to select an image.

An operation accepted from the second touch panel 1008 is layer movement processing which is a double tap operation on the second touch panel 1008. This is because when the user holds the information processing apparatus 100, fingers or the palm of his/her hand always touches the second touch panel 1008 arranged on the rear surface, thereby causing a malfunction and impairing the user convenience.

Note that although the above explanation has been provided in this embodiment, the present invention is not limited to this. In the example, since a double tap operation in which the user successively taps almost the same position twice within a predetermined time is less likely to be erroneously performed as compared with a single tap or flick operation, it is allowed as an operation on the rear surface. However, selection of an image by a single tap on the rear surface may be allowed if the possibility of an erroneous operation is not a concern. It may be possible to allow another operation such as a flick or pinch operation, similarly to the touch panel arranged on the front surface.

<Layer Movement Processing Procedure>

FIG. 7 is a flowchart illustrating the layer movement processing procedure in step S107 of the flowchart shown in FIG. 5. The CPU 1001 executes the processing procedure shown in FIG. 7 unless otherwise specified, and will thus be omitted in a description of the processing procedure. As described with reference to FIG. 5, this procedure determines, when the first touch panel 1007 arranged on the front surface of the information processing apparatus 100 or the second touch panel 1008 arranged on the rear surface of the information processing apparatus 100 is double tapped, that layer movement processing is to be performed, and executes the processing.

In step S201, the state of the selection flag 304 of the image management table 300 is checked, and currently selected images are determined. If at least one of the images is currently selected, the process advances to step S202.

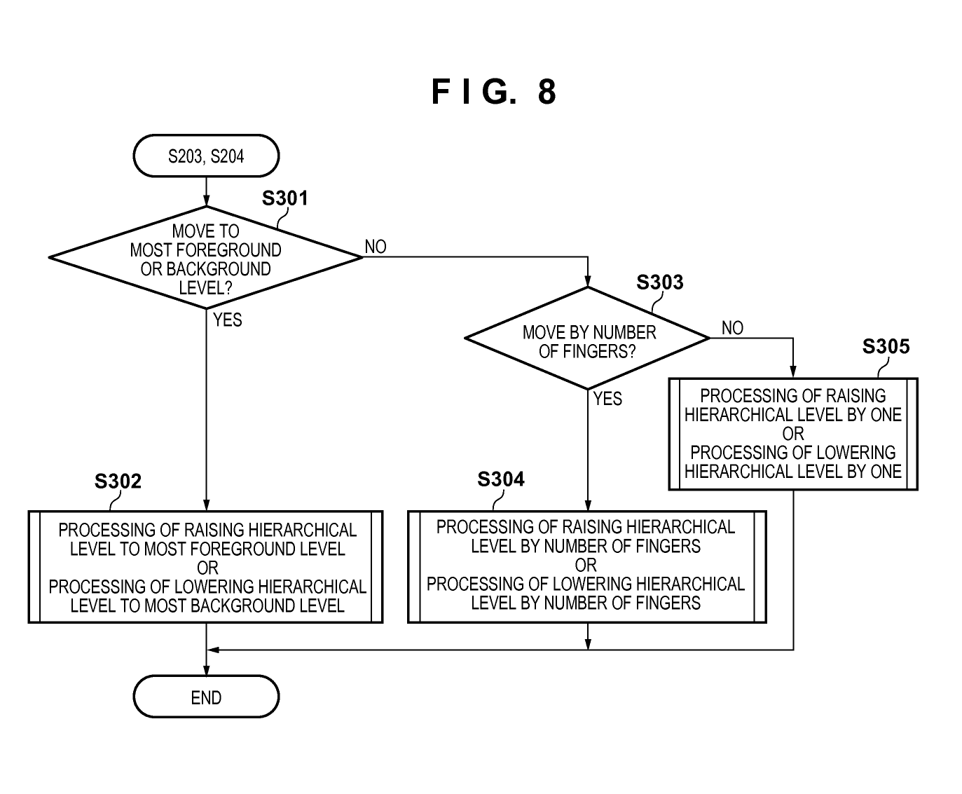

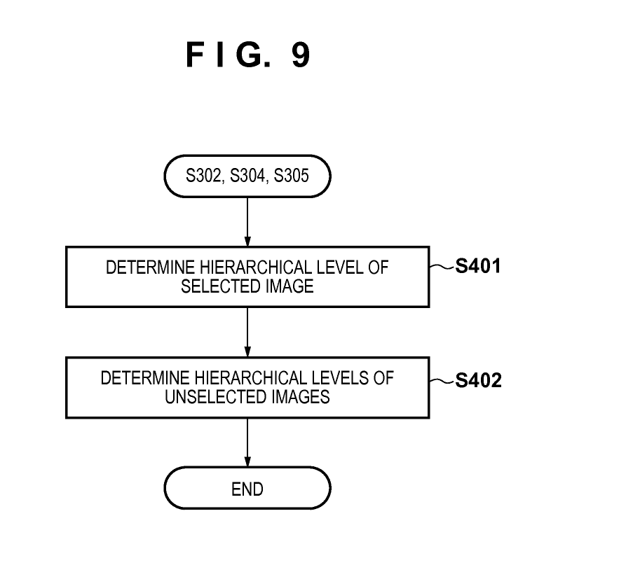

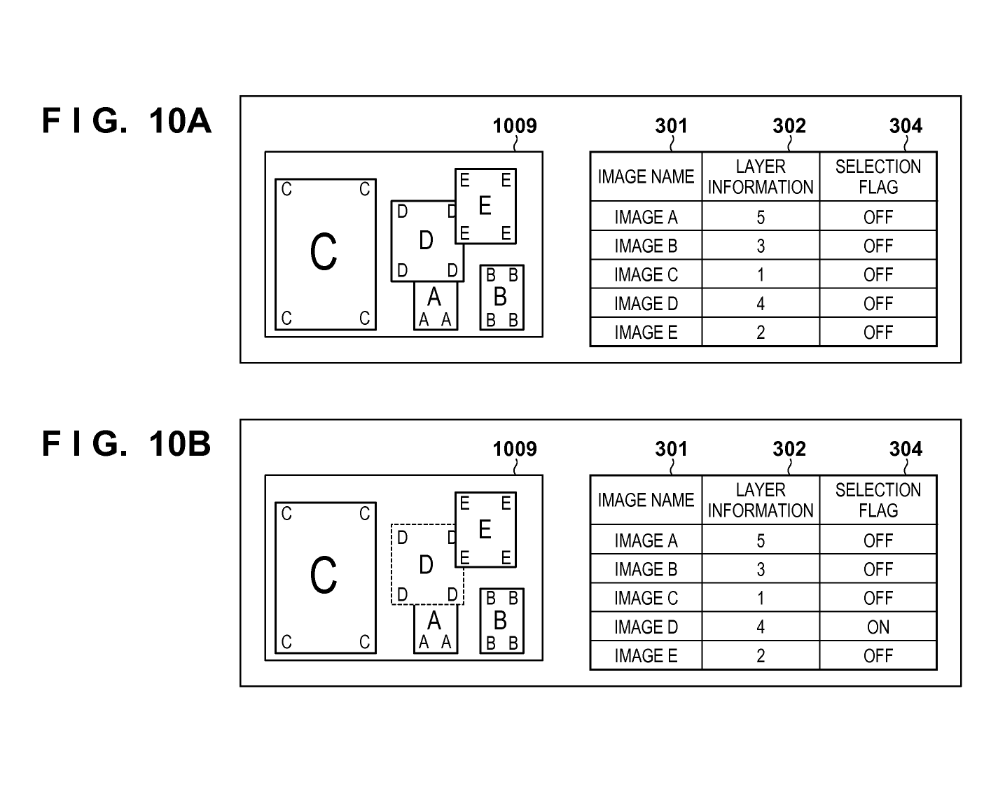

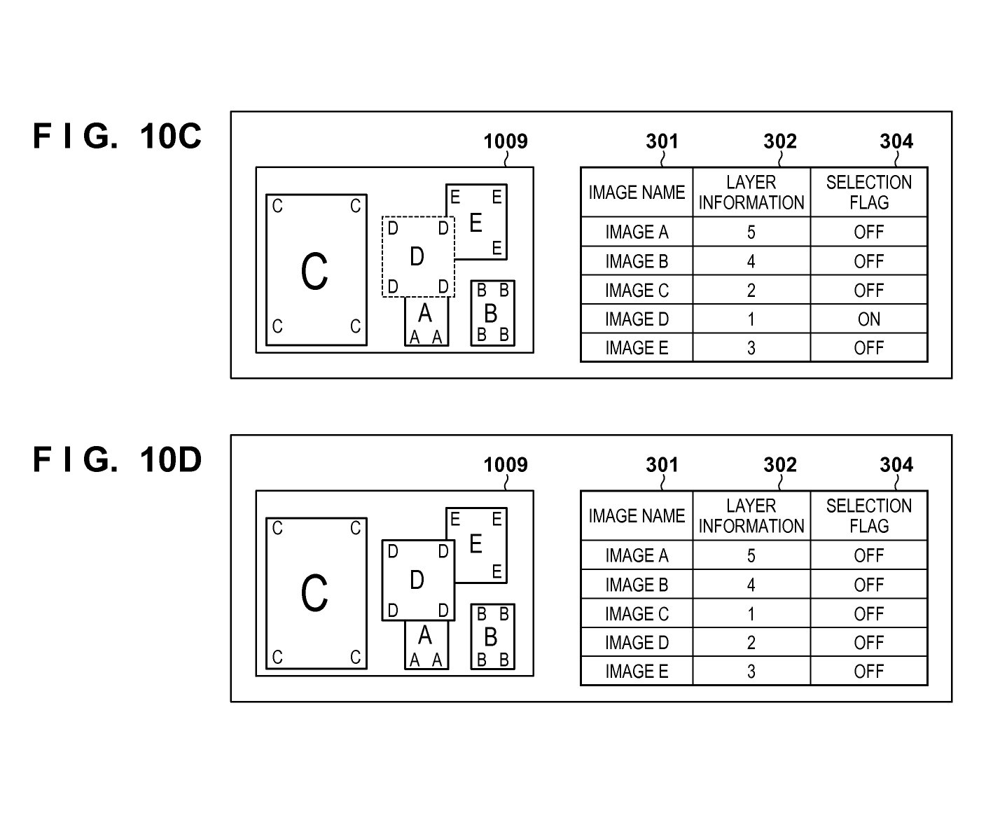

In step S202, it is determined whether the first touch panel 1007 arranged on the front surface of the information processing apparatus 100 or the second touch panel 1008 arranged on the rear surface of the information processing apparatus 100 has been double tapped. If the first touch panel on the front surface has been double tapped, the hierarchical level of the selected image is lowered in step S203. If the second touch panel on the rear surface has been double tapped, the hierarchical level of the selected image is raised in step S204. A layer movement unit used in step S203 and S204 will be described later with reference to flowcharts shown in FIGS. 8 and 9 and views shown in FIGS. 10A to 13B.

If it is determined in step S201 that no image is currently selected, the process advances to step S205. In step S205, it is determined whether the first touch panel 1007 arranged on the front surface of the information processing apparatus 100 or the second touch panel 1008 arranged on the rear surface of the information processing apparatus 100 has been double tapped.

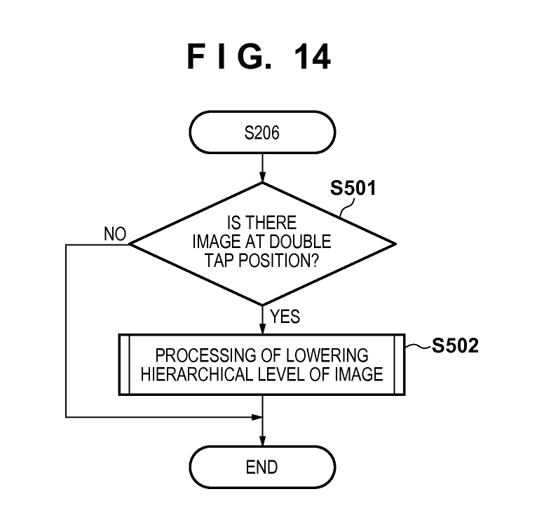

If the first touch panel on the front surface has been double tapped and an image exists at the double tap position, the process advances to step S206 in which processing of lowering the hierarchical level of the image at the double tap position is executed. The procedure in step S206 will be described in detail later with reference to FIG. 14.

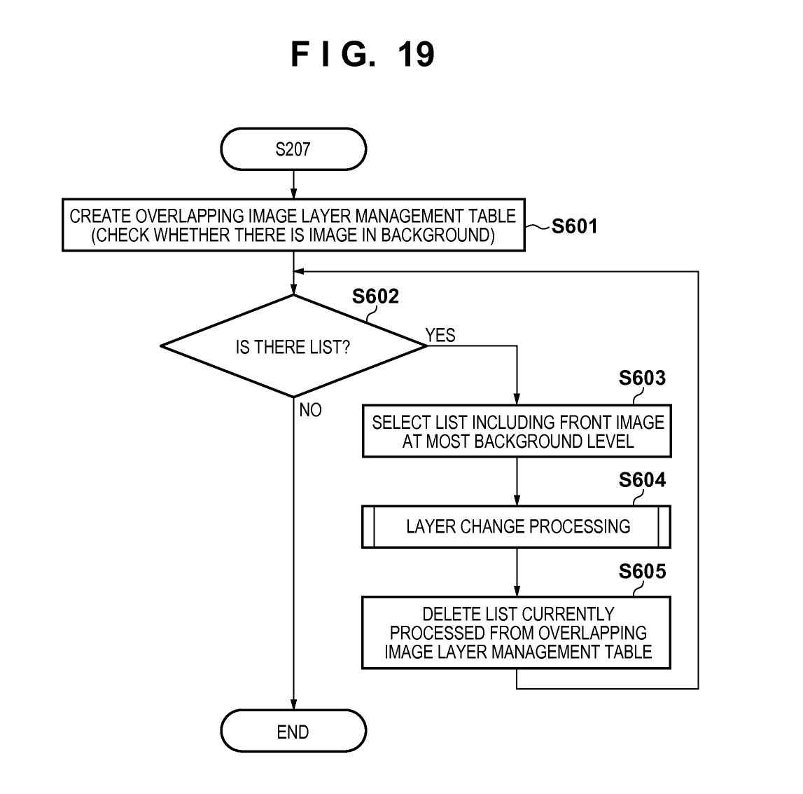

If the second touch panel on the rear surface has been double tapped, processing of changing the layer information 302 of the image management table 300 to display an image hidden behind another image on the liquid crystal display 1009 is performed in step S207. The processing procedure in step S207 will be described in detail later with reference to FIG. 19.

The processing procedure in steps S202 to S204 which is performed when it is determined in step S201 that at least one image is currently selected is assumed to be executed when images selectable by the user are displayed on the liquid crystal display 1009 and at least one of the displayed images is currently selected.

On the other hand, the processing procedure in steps S205 and S206 which is performed when it is determined in step S201 that no image is currently selected assumes that an image to be operated is displayed to be seen by the user. It is therefore possible to omit image selection processing by the user by lowering the hierarchical level of the image at the double tap position even if the image selection processing is not performed in steps S103 and S105 of FIG. 5. A detailed description will be provided with reference to FIG. 14 and the like.

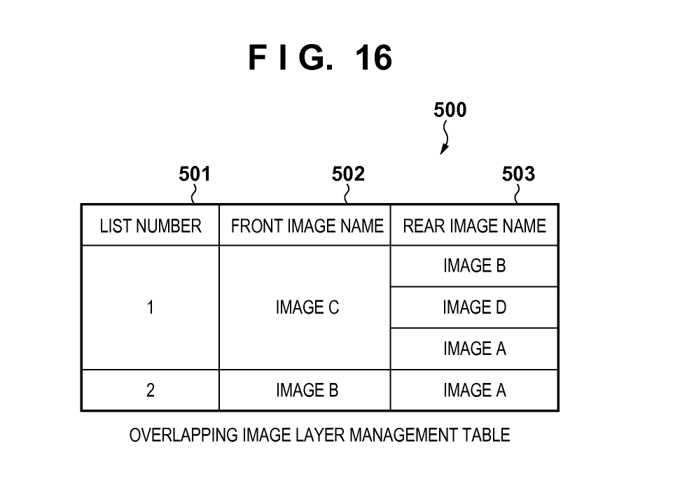

The processing procedure in steps S205 and S207 which is performed when it is determined in step S201 that no image is currently selected assumes a case in which a plurality of images overlap each other on the liquid crystal display 1009 and one image is entirely hidden behind another image. For example, image B is entirely hidden behind image A, and thus image B cannot be selected in this state. A detailed description will be provided with reference to FIG. 16 and the like.

The reason why double tap processing on the first touch panel 1007 is assigned to processing of lowering the hierarchical level of an image is that the double tap processing gives a sensation of pressing down the image from the front surface to the rear surface, and is intuitive processing of lowering the hierarchical level of the image. The reason why double tap processing on the second touch panel 1008 is assigned to processing of raising the hierarchical level of an image is that the double tap processing gives a sensation of pushing up the image from the rear surface to the front surface, and is intuitive processing of raising the hierarchical level of the image. That is, the movement direction of the layer of the image coincides with the direction of a tap. Although the correspondence between a gesture operation and the operation of an image is determined to improve the operability, the present invention is not limited to this, as a matter of course.

<Layer Movement Unit>

FIG. 8 is a flowchart illustrating the layer movement unit used in steps S203 and S204 of the flowchart shown in FIG. 7. The CPU 1001 executes the processing procedure shown in FIG. 7 unless otherwise specified, and will thus be omitted in a description of the processing procedure.

In this embodiment, the layer movement unit has three modes for moving the layer of a selected image. In the first mode, the layer of a selected image is moved to the most foreground or background level. In the second mode, the layer of a selected image is moved according to the number of fingers with which a double tap is performed. In the third mode, the layer of a selected image is moved by one hierarchical level. Even if the same operation is performed, processing for an image changes depending on the selected mode. Note that to realize the second mode, it is necessary to allow, on the first touch panel, a multi-touch operation capable of simultaneously detecting touches at a plurality of positions. Which of the three modes is used to operate is preset according to a user's use method, and is stored in the RAM 1002. Alternatively, the user can set a mode via the first touch panel 1007 before performing layout processing.

A case in which the second touch panel 1008 of the information processing apparatus 100 is double tapped to raise the hierarchical level of a selected image will be described here.

In step S301, it is determined whether the current mode is the first mode in which the layer is moved to the most foreground level. If it is determined that the current mode is the first mode, the process advances to step S302. In step S302, the layer of the selected image is moved to the most foreground level, and the hierarchical levels of other unselected images are also changed according to the hierarchical level of the image which has been moved to the most foreground level.

If it is determined in step S301 that the current mode is not the first mode, the process advances to step S303. In step S303, it is determined whether the current mode is the second mode in which the layer of the selected image is moved according to the number of fingers with which a double tap has been performed. If it is determined that the current mode is the second mode, the process advances to step S304. In step S304, the hierarchical level of the selected image is raised according to the number of fingers with which a double tap has been performed on the second touch panel 1008. If, for example, the number of fingers with which a double tap has been performed is three, the hierarchical level of the selected image is raised by three from the current hierarchical level. The layers of the remaining unselected images are also changed according to the layer of the image which has been moved to the foreground. Note that if the hierarchical level of the image exceeds the highest hierarchical level when it is raised by a designated number, the hierarchical level after movement is set to the highest one.

If it is determined in step S303 that the current mode is not the second mode, it is determined that the current mode is the third mode in which the layer of the selected image is moved by one hierarchical level, and the process advances to step S305. In step S305, the hierarchical level of the selected image is raised by one hierarchical level. The layers of the remaining unselected images are also changed according to the layer of the image which has been moved to the foreground.

A case in which the second touch panel 1008 of the information processing apparatus 100 is double tapped to raise the hierarchical level of the selected image has been described with reference to FIG. 8. However, if the first touch panel 1007 is double tapped, processing of lowering the hierarchical level of the selected image is executed according to a processing procedure similar to that shown in FIG. 8. The difference is that an operation on the first touch panel moves the selected image not to the most foreground level but to the most background level in step S302. Another difference is that the hierarchical level of the selected image is lowered according to the number of fingers in step S304. Still another difference is that the hierarchical level of the selected image is lowered by one in step S305.

The processes in steps S302, S304, and S305 are implemented when the CPU 1001 updates the layer information 302 of the image management table 300. A method of updating the layer information 302 of the image management table 300 will be described with reference to a processing procedure shown in FIG. 9.

<Method of Updating Image Management Table>

FIG. 9 is a flowchart for explaining the method of updating the layer information 302 of the image management table 300 when the layer of the selected image is moved in step S302, S304, or S305 of the flowchart shown in FIG. 8. The CPU 1001 executes the processing procedure shown in FIG. 8 unless otherwise specified, and will thus be omitted in a description of the processing procedure.

In step S401, the movement destination layer of the selected image is determined first. The movement destination layer is determined depending on the selected one of the three modes described with reference to FIG. 8 with reference to the current hierarchical level. If the movement destination layer is at a hierarchical level exceeding the most foreground or background level, the image is moved to the most foreground or background level. If a plurality of images are selected and moved to the most foreground or background level, they are moved to the most foreground or background level while maintaining their original hierarchical relationship before movement.

In step S402, hierarchical levels other than the hierarchical level of the selected image which has been determined in step S401 are sequentially assigned to the remaining unselected images while maintaining their original hierarchical relationship.

Together with a screen displayed on the liquid crystal display 1009, a method of updating the layer information 302 of the image management table 300 in each mode will be described below with reference to FIGS. 10A to 13B. In the following description of FIGS. 10A to 13B, the CPU 1001 updates the image management table 300 and the screen displayed on the liquid crystal display 1009, as a matter of course. In the following description of FIGS. 10A to 13B, therefore, the CPU 1001 serving as a processor will be omitted.

<Example of Update of Image Management Table (First Mode)>

FIGS. 10A to 10D are views showing an example of the method of updating the layer information 302 of the image management table 300 in the first mode in which the selected image is moved to the most foreground or background level according to the procedure shown in FIG. 8. More specifically, FIGS. 10A to 10D are views showing a case in which the user selects an unselected image, moves the layer of the selected image, and cancels the selected state of the selected image. Each of FIGS. 10A to 13B shows the state of the image management table 300 in the right portion and display of the liquid crystal display 1009 corresponding to the state in the left portion.

FIG. 10A is a view showing a display state in which no image is currently selected. The hierarchical level of each image at this time is as shown in the image management table 300 of FIG. 10A.

FIG. 10B is a view showing a state in which the user has single tapped the position of image D on the first touch panel 1007 to select this image in the state shown in FIG. 10A. The selection flag 304 of image D is turned on, and the frame of image D on the liquid crystal display 1009 is indicated by dotted lines, thereby representing that this image is currently selected.

FIG. 10C is a view showing a state in which the user has double tapped the second touch panel 1008 in the state shown in FIG. 10B. This example is an operation example in the first mode. The operation indicates that the user attempts to move the layer of image D to the most foreground level.

The example will be explained based on the method of updating the layer information 302 of the image management table 300, which has been described with reference to the procedure shown in FIG. 9. To move the layer of the selected image, that is, image D to the most foreground level, the value of the layer information 302 of image D is updated to a value indicating the highest hierarchical level, that is, “1”. Processing up to this operation corresponds to the processing in step S401 of FIG. 9.

A method of changing the pieces of layer information 302 of unselected images A, B, C, and E will be described next. Processing corresponding to step S402 of the processing procedure shown in FIG. 9 will be explained below. Since the value of the layer information 302 indicating the hierarchical level of image D determined in step S401 is “1”, values of “2” to “5” other than “1” are assigned to unselected images A, B, C, and E while maintaining their hierarchical relationship. In the state shown in FIG. 10B, the hierarchical levels are higher in the order of images C, E, B, and A. Therefore, the hierarchical levels “2” to “5” are assigned to the respective images while maintaining the above hierarchical relationship. As a result, the layer information 302 of image C is “2”, that of image E is “3”, that of image B is “4”, and that of image A is “5”.

FIG. 10D is a view showing a state in which the user has single tapped the position of image D on the first touch panel 1007 to cancel the selection of the image in the state shown in FIG. 10C.

<Example of Update of Image Management Table (Third Mode)>

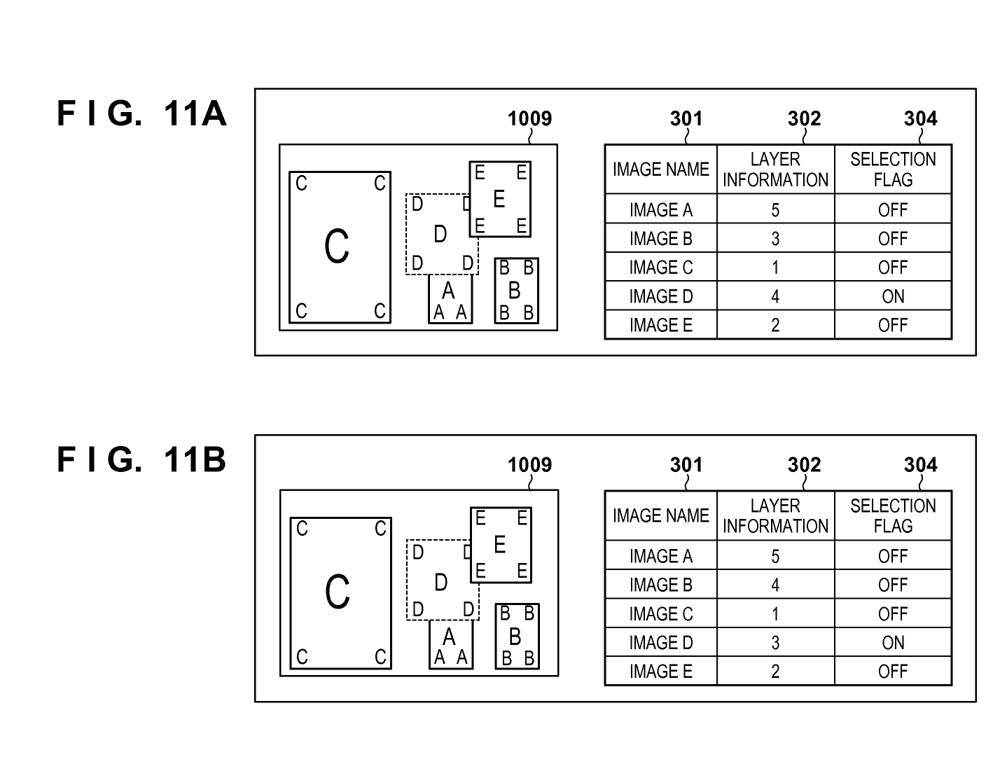

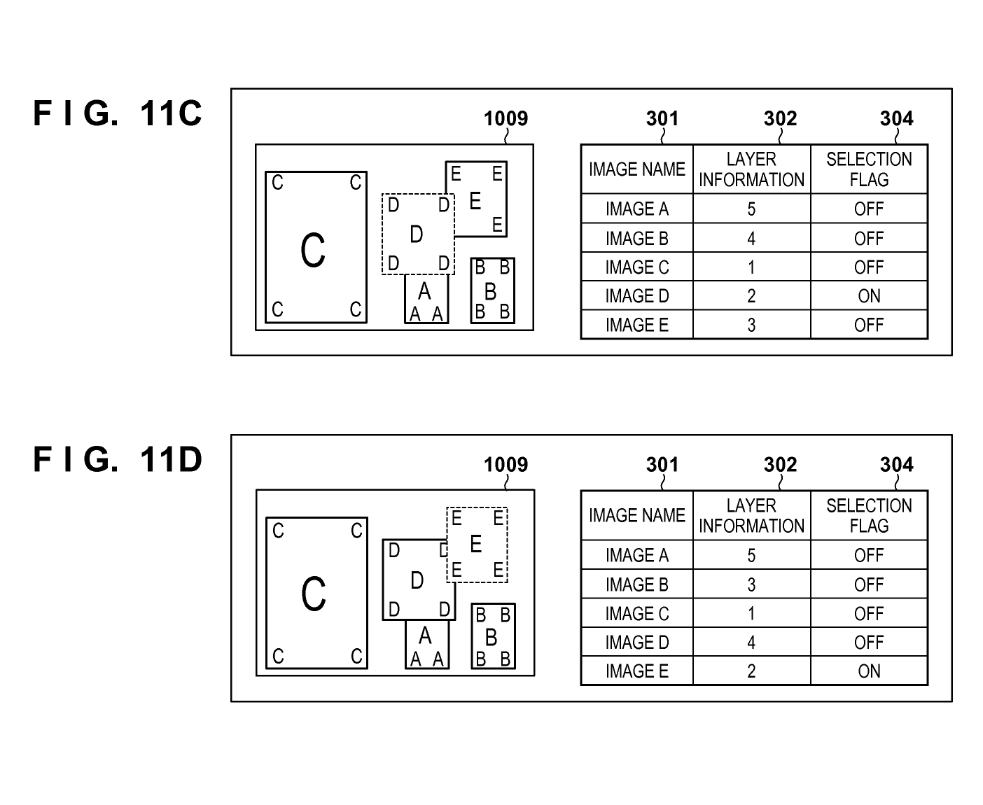

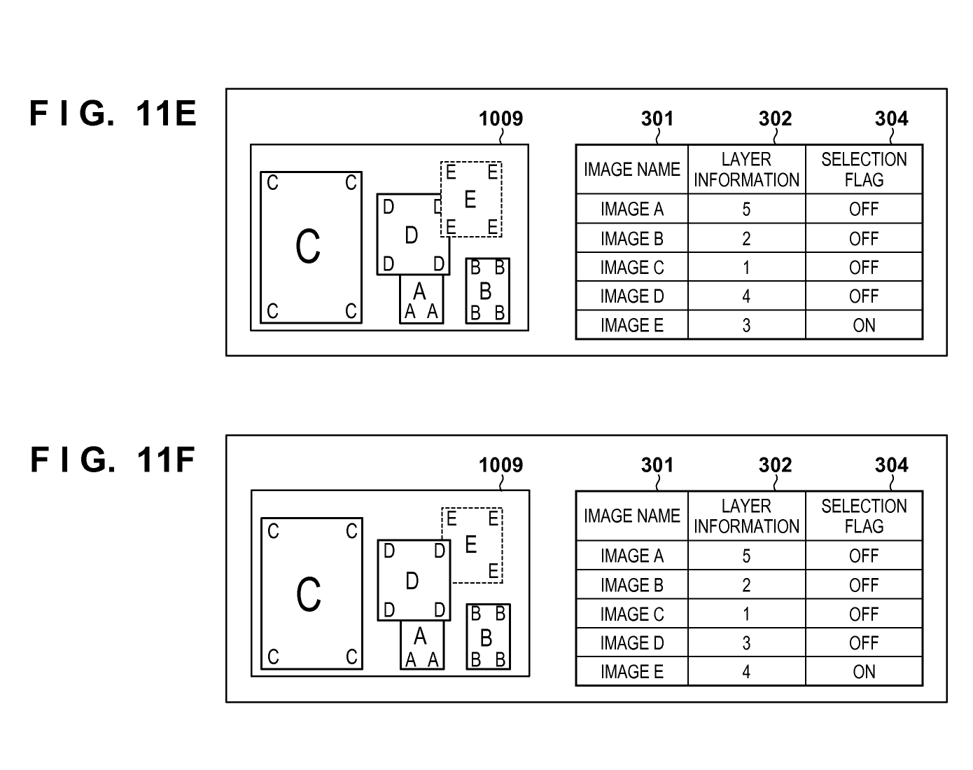

FIGS. 11A to 11F are views for explaining an example of the method of updating the layer information 302 of the image management table 300 in the third mode in which the layer of the selected image is moved by one hierarchical level according to the procedure shown in FIG. 8.

FIG. 11A shows a state in which image D has been selected, which is the same as that shown in FIG. 10B. FIG. 11B is a view showing a state in which the user has double tapped the second touch panel 1008 in the state shown in FIG. 11A. That is, FIG. 11B shows a case in which the user attempts to raise the hierarchical level of selected image D by one. The method of updating the layer information 302 of the image management table 300 will be described below. The basic idea of the method of updating the layer information 302 of the image management table 300 has been explained with reference to FIGS. 9 and 10A to 10D and a detailed description thereof will be omitted.

The hierarchical level of image D is raised by one. Since the value of the layer information 302 of image D in the state shown in FIG. 11A is “4”, it is raised by one, that is, it is updated to “3”. Since the value of the layer information 302 indicating the hierarchical level of image D is “3”, values of “1”, “2”, “4”, and “5” other than “3” are assigned to unselected images A, B, C, and E while maintaining their hierarchical relationship. Therefore, the layer information 302 of image C is “1”, that of image E is “2”, that of image B is “4”, and that of image A is “5”. This operation switches the hierarchical levels of images D and B in the image management table 300. However, images D and B do not overlap each other, and their display in FIG. 11B is the same as that in FIG. 11A.

FIG. 11C is a view showing a state in which the user has double tapped the second touch panel 1008 in the state shown in FIG. 11B. That is, FIG. 11C shows a case in which the user attempts to further raise the hierarchical level of image D by one. The method of updating the layer information 302 of the image management table 300 has been described above and only the result will be explained. The value of the layer information 302 of selected image D is raised to “2”. The values other than “2” are assigned to unselected images A, B, C, and E while maintaining their hierarchical relationship. As a result, the layer information 302 of image C is “1”, that of image E is “3”, that of image B is “4”, and that of image A is “5”. This operation switches the hierarchical levels of images D and E in the image management table 300. Since images D and E overlap each other, image D is displayed on image E in FIG. 11C.

Unlike FIGS. 11A to 11C, a case in which the hierarchical level of the selected image is lowered will be described next.

FIG. 11D shows a state in which image E has been selected in the state shown in FIG. 10A. FIG. 11E is a view showing a state in which the user has double tapped the first touch panel 1007 in the state shown in FIG. 11D. That is, FIG. 11E shows a case in which the user attempts to lower the hierarchical level of image E by one. The value “2” of the layer information 302 of image E is lowered by one, that is, it is updated to “3”. The values other than “3” are assigned to images A, B, C, and D while maintaining their hierarchical relationship. Consequently, the layer information 302 of image C is “1”, that of image B is “2”, that of image D is “4”, and that of image A is “5”.

FIG. 11F is a view showing a state in which the user has double tapped the first touch panel 1007 in the state shown in FIG. 11E. The value of the layer information 302 of image E is changed from “3” to “4”, and the values other than “4” are assigned to images A, B, C, and D while maintaining their hierarchical relationship. Consequently, the layer information 302 of image C is “1”, that of image B is “2”, that of image D is “3”, and that of image A is “5”.

If the processes shown in FIGS. 11A to 11C are performed to display image D without being hidden behind any other images, it is also possible to display image D in the foreground by lowering the hierarchical level of image E as shown in FIGS. 11D to 11F. That is, if there are a target image and an overlapping image overlapping the target image, the object can be achieved by performing an operation of raising the hierarchical level of the target image to be higher than that of the overlapping image, or an operation of lowering the hierarchical level of the overlapping image to be lower than that of the target image.

<Example of Update of Image Management Table (Second Mode)>

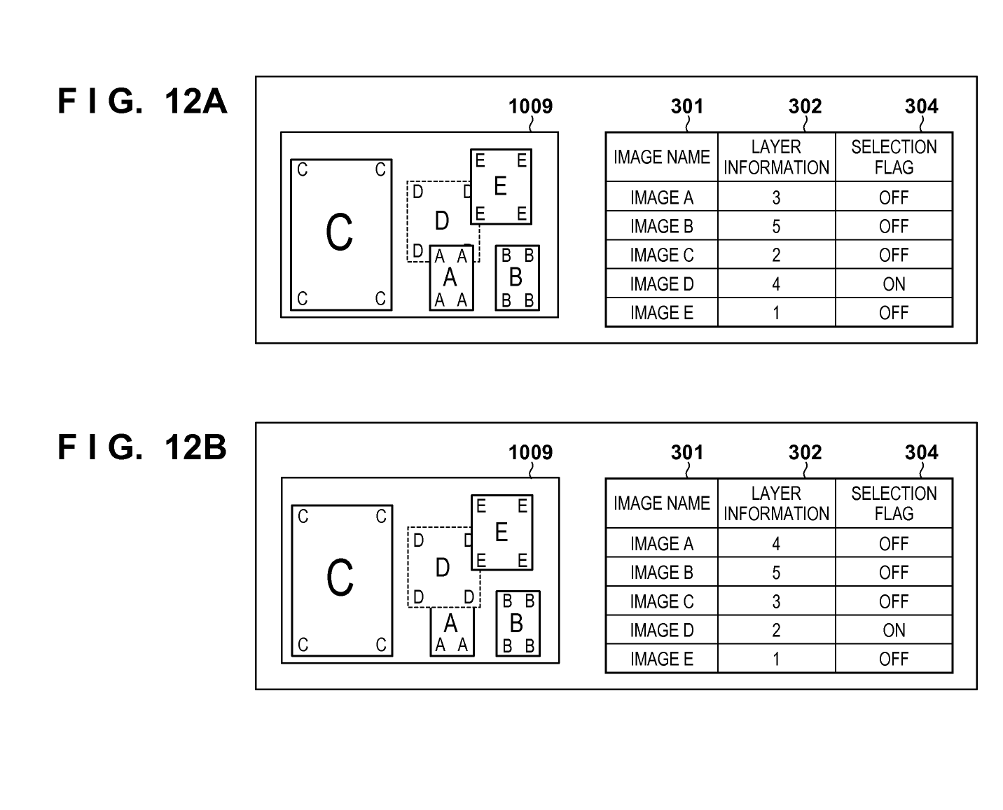

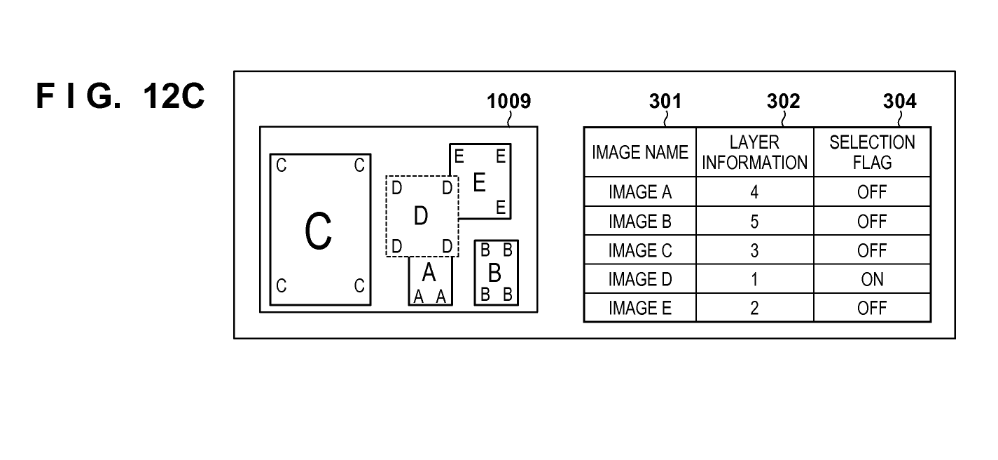

FIGS. 12A to 12C are views for explaining an example of the method of updating the layer information 302 of the image management table 300 in the second mode in which the hierarchical level of the selected image is moved according to the number of fingers with which a double tap has been performed according to the procedure shown in FIG. 8.

FIG. 12A shows a state in which image D has been selected. FIG. 12B is a view showing a state in which the user has double tapped the second touch panel 1008 with two fingers in the state shown in FIG. 12A. That is, FIG. 12B shows a case in which the user attempts to raise the hierarchical level of image D by two. The basic idea of the method of updating the layer information 302 of the image management table 300 has been described with reference to FIGS. 9 to 11F and a detailed description thereof will be omitted.

To raise the hierarchical level of image D by two, the value of the layer information 302 of image D is updated to “2” by subtracting two from the current hierarchical level “4”, and the values other than “2” are assigned to images A, B, C, and E while maintaining their hierarchical relationship. As a result, the layer information 302 of image E is “1”, that of image C is “3”, that of image A is “4”, and that of image B is “5”.

FIG. 12C is a view showing a state in which the user has further double tapped the second touch panel 1008 with two fingers in the state shown in FIG. 12B. That is, FIG. 12C shows a case in which the user attempts to raise the hierarchical level of image D by two.

If the user attempts to raise the hierarchical level of image D by two, the hierarchical level of image D would exceed the most foreground level “1” since the value of the layer information 302 of image D is currently “2”. As described with reference to step S401 of FIG. 9, therefore, the value of the layer information 302 of image D is updated to “1” indicating the most foreground level. The values other than “1” are assigned to the pieces of layer information 302 of unselected images A, B, C, and E while maintaining their hierarchical relationship. Consequently, the layer information 302 of image E is “2”, that of image C is “3”, that of image A is “4”, and that of image B is “5”.

When the user double taps the second touch panel 1008 with three fingers in the state shown in FIG. 12A, the hierarchical level of image D is raised by three to directly transit to the state shown in FIG. 12C.

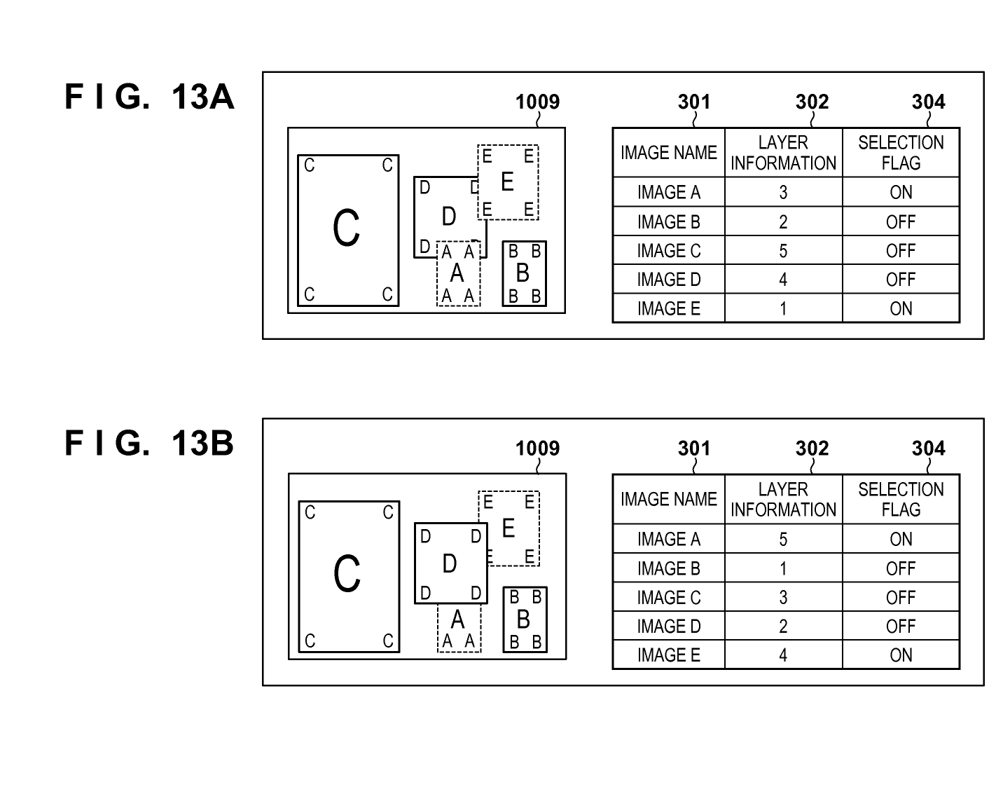

FIGS. 13A and 13B are views for explaining an example of the method of updating the layer information 302 of the image management table 300 when a plurality of images are selected. FIGS. 13A and 13B are views showing an example of the method of updating the layer information 302 of the image management table 300 in the first mode in which a selected image is moved to the most foreground or background level according to the processing procedure shown in FIG. 8.

FIG. 13A shows a state in which images A and E have been selected. FIG. 13B is a view showing a state in which the user has double tapped the first touch panel 1007 in the state shown in FIG. 13A. That is, FIG. 13B shows a case in which the user attempts to change the layers of images A and E to the most background level. The basic idea of the method of updating the layer information 302 of the image management table 300 has been described with reference to FIGS. 9 to 12C and only characteristic parts of the layer movement method will be described in detail.

In step S401 of FIG. 9, the movement destination layers of the selected images are determined. In the example shown in FIG. 13A, two images A and E have been selected. If a plurality of images are selected and their layers are moved to the most background level, the selected images are moved to the most background level while maintaining their hierarchical relationship before movement. That is, to lower the hierarchical levels, an image of the lowest layer among the selected images is specified and the layer of the specified image is changed according to the mode and operation. After that, the layers of the remaining selected images are also changed so that their hierarchical levels become higher than an image of the lowest hierarchical level. To raise the hierarchical levels, an image of the highest layer among the selected images is specified and the layer of the specified image is changed according to the mode and operation. After that, the hierarchical levels of the remaining selected images are also changed so that they become lower than an image of the highest hierarchical level. The remaining layers which have not been assigned yet are assigned to unselected images while maintaining their hierarchical relationship before layer movement.

Referring to FIG. 13A, the values of the pieces of layer information 302 of images A and E are “3” and “1”, respectively, and image A is at the lower hierarchical level. Therefore, the value of the layer information 302 of image A is updated from “3” to “5”, and the value of the layer information 302 of image E is updated from “1” to “4”.

Next, values of “1” to “3” other than “4” and “5” are assigned to unselected images B, C, and D while maintaining their hierarchical relationship before layer movement. As a result, the layer information 302 of image B is “1”, that of image D is “2”, and that of image C is “3”.

Any of the methods shown in FIGS. 10A to 13B can be used to move the layer of an image desired by the user, that is, change the layer of a designated image to another layer. This can readily realize a layout operation when the user lays out a plurality of images within one page, especially when the user wants to lay out a plurality of images to overlap each other. It is also possible to select whether to change a layer by setting a layer after the change to a predetermined layer or by raising or lowering a layer by a predetermined or designated number of layers.

In this embodiment, a unit for raising the hierarchical level of a designated image is implemented by a double tap on the second touch panel. If, however, the second touch panel is not provided, it is possible to implement the unit by preparing a unit for raising a hierarchical level on the first touch panel. For example, it is possible to implement the unit by assigning a triple tap operation on the first touch panel to processing of raising the hierarchical level of an image. Furthermore, a pin tab (not shown) can be provided in the information processing apparatus 100 and processing of raising the hierarchical level of an image can be assigned to the pin tab, thereby implementing the unit by the processing of raising the hierarchical level.

Even if there is no need for processing of raising a hierarchical level, it is possible to lay out images in consideration of its hierarchical levels by performing processing of lowering the hierarchical level of an image selected several times in the past.

Moreover, lowering the hierarchical level of an image displayed in the foreground makes it possible to select an image hidden behind that image while maintaining the layout positions of the images.

<Image Layer Movement when there is No Selected Image>

The processing in step S206 of FIG. 7 aims to intuitively lower the hierarchical level of an image without requiring selection of the image. Although the processing in step S203 or S204 always requires selection of an image displayed on the liquid crystal display 1009, the processing in step S206 does not require selection of an image, thereby reducing the user's labor.

<Processing Procedure of Lowering Hierarchical Level of Image According to Double Tap Position>

FIG. 14 is a flowchart illustrating the processing procedure of lowering the hierarchical level of an image according to a tap position in step S206 of the flowchart shown in FIG. 7. The CPU 1001 executes the processing procedure shown in FIG. 14 unless otherwise specified, and will thus be omitted in a description of the processing procedure.

In step S501, by referring to the position information 303 of the image management table 300, it is determined whether an image exists at a double tap position on the first touch panel 1007. If no image exists, the process ends. If it is determined in step S501 that an image exists, the process advances to step S502 to lower the hierarchical level of the image. In the processing procedure of step S502, the same processing as that of the layer movement unit shown in FIGS. 8 and 9 is executed. Although the processing procedure is the same, there is a difference from step S204. That is, processing is performed for a selected image in the first embodiment but processing is performed in step S502 for the image which has been determined to be at the double tap position in step S501. The hierarchical level is lowered in step S502, and this operation is the same as that shown in FIG. 8 which is called in step S203 of FIG. 7. Note that if it is determined in step S501 that a plurality of images overlap each other at the double tap position, processing of lowering the hierarchical level of an image having a highest hierarchical level by referring to the state of the layer information 302 is performed.

<Method of Updating Image Management Table>

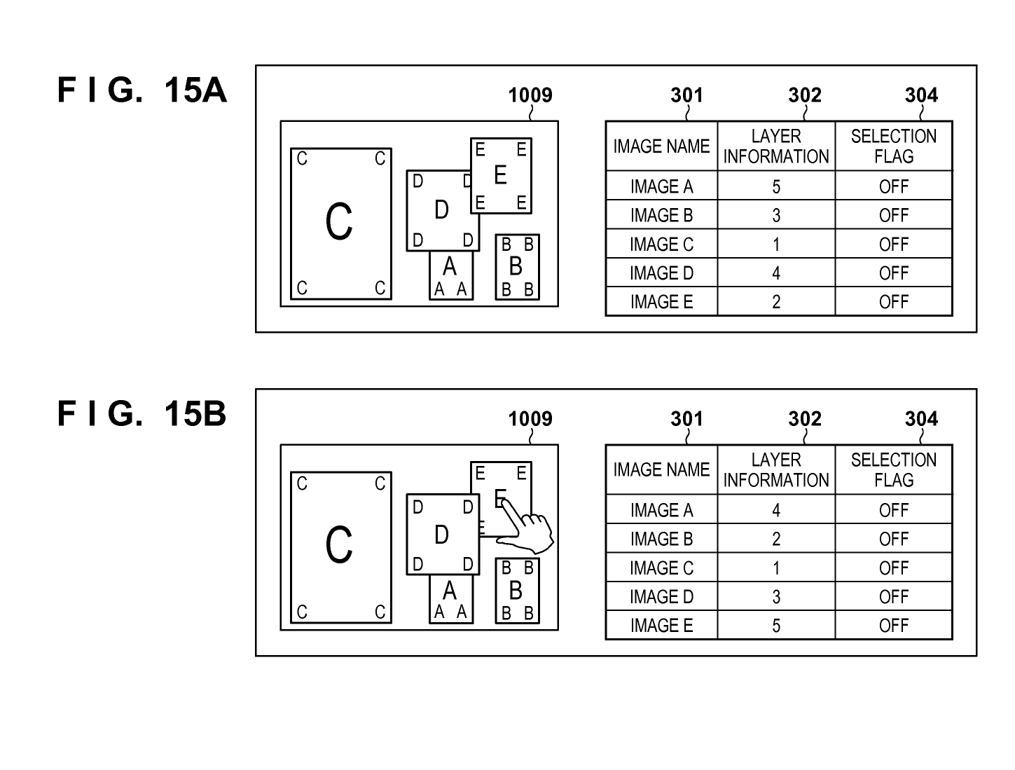

FIGS. 15A and 15B are views showing an example of the method of updating the layer information 302 of the image management table 300 in the processing of step S206 of FIG. 7. More specifically, FIGS. 15A and 15B are views showing a case in which the user double taps the position of image E on the first touch panel 1007 while no image is selected. In this example, the procedure of lowering the hierarchical level in step S502 of FIG. 14 will be described by assuming a mode (that is, step S302) in which a selected image is moved to the most background level according to the procedure shown in FIG. 8.

FIGS. 15A and 15B are views each showing display of the liquid crystal display 1009 in the left portion and the state of the image management table 300 in the right portion. FIG. 15A is a view showing a state in which no image has been selected. FIG. 15B is a view showing a state in which the user has double tapped the position of image E on the first touch panel 1007 in the state shown in FIG. 15A. The CPU 1001 refers to the position information 303 of the image management table 300 in step S501 of FIG. 14, and determines an image at the double tap position. In the example shown in FIG. 15A, if the user double taps image E, there is only image E or images D and E at the position. If the user double taps a position where image D (hierarchical level “4”) and image E (hierarchical level “2”) overlap each other, image E of the upper layer is to be moved. Therefore, in either case, image E undergoes layer movement.

In step S502 of FIG. 14, processing of moving the layer of image E to the most background level is executed. The method of updating the layer information 302 of the image management table 300 has been already described and a detailed description thereof will be omitted. At this time, the pieces of selection flag 304 of images A to E are kept OFF, and only the pieces of layer information 302 are updated. A layer movement operation changes the hierarchical level of image E from the hierarchical level “2” before the change to the lowest hierarchical level “5”. Movement of the layer of image E has no influence on an image having a hierarchical level higher than that of image E before the change, in this example, image C having the hierarchical level “1”. Furthermore, movement of the layer of image E has no influence on an image having a hierarchical level lower than that of image E after the change, either. Since, however, image E moves to the lowest hierarchical level in this example, there is no corresponding image. The hierarchical levels of images before the change, which fall within the range between the hierarchical levels of image E before and after the change, in this example, the hierarchical levels of images A, B, and D are raised by one, respectively.

In the above example, to change the hierarchical level of a selected image, the first touch panel 1007 is single tapped to select an image, and is then double tapped to lower the hierarchical level of the selected image. In this example, however, it is not necessary to select an image. As described above, it is possible to reduce the user's labor since selection of an image is not required.

<Layer Movement of Image Hidden Behind Another Image>

Step S207 of FIG. 7 aims at an operation and processing in which when the whole or most of image B is hidden behind image A and thus image B cannot be selected, image B hidden behind image A is brought to the foreground. For example, if the following case applies, the processing is effective. For example, the user enlarges an image during layout processing, and thus another image is hidden behind the enlarged image. Or, the user wants to move an image hidden behind an enlarged image to the foreground to perform an operation such as selection or movement while maintaining the position of the enlarged image.

<Overlapping Image Layer Management Table>

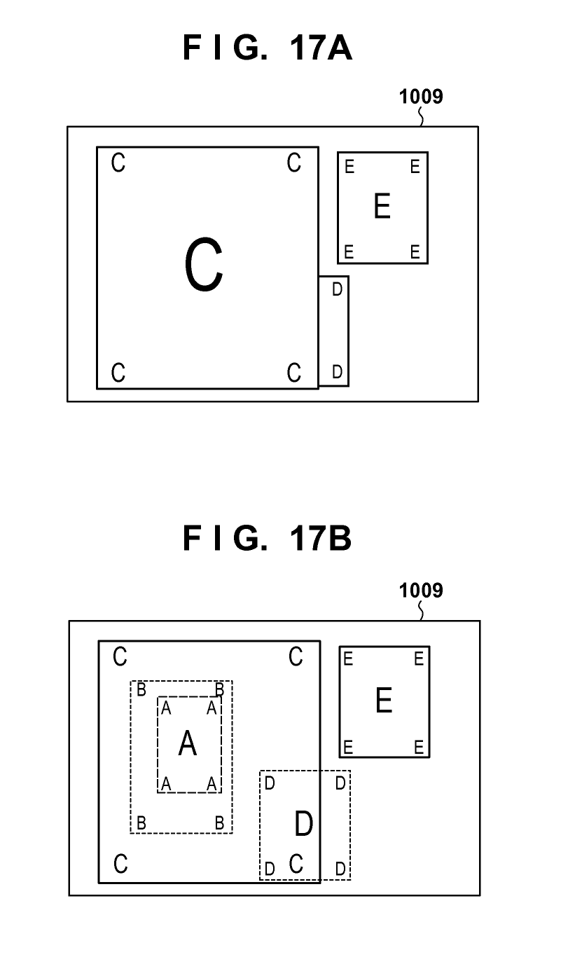

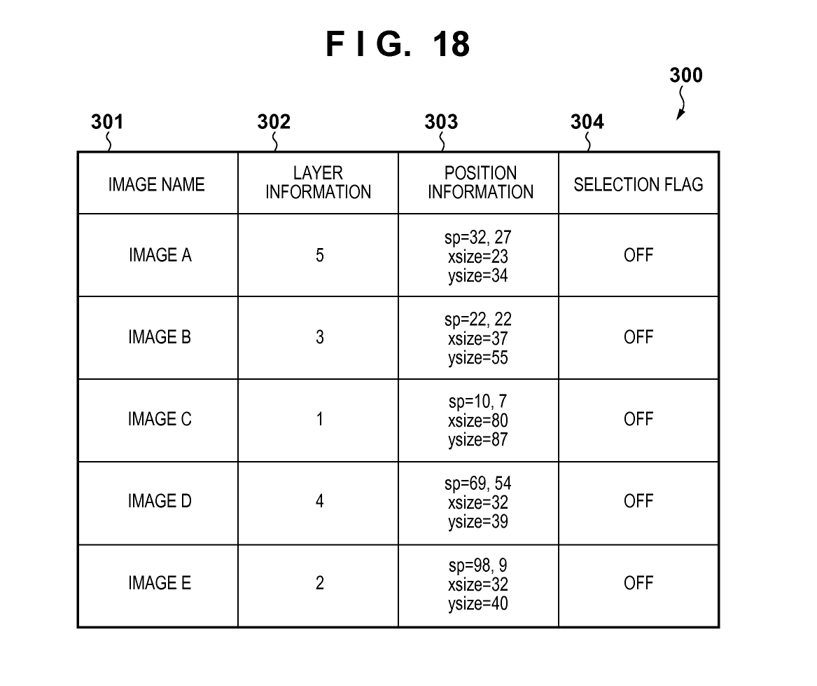

FIG. 16 is a table showing an overlapping image layer management table 500. The overlapping image layer management table 500 is necessary to move the layer of an image hidden behind another image, and is managed and updated by the CPU 1001. The overlapping image layer management table 500 indicates overlapping of images, and is generated when a plurality of images overlap each other. That is, the overlapping image layer management table 500 is created in step S601 of FIG. 19 in this example. However, when a new image record is added to the image management table 300 or the position or size of an existing image is changed, the overlapping image layer management table 500 may be created or updated by detecting overlapping images based on the positions and sizes of respective images. The overlapping image layer management table 500 will be described with reference to FIGS. 17A, 17B, and 18.

FIGS. 17A and 17B are views each showing images displayed on the liquid crystal display 1009 when the image management table 300 is in a state shown in FIG. 18. FIG. 17A shows a screen itself displayed on the liquid crystal display 1009. Referring to FIG. 17B, images A, B, and D hidden behind image C can be seen. Note that the images actually displayed on the liquid crystal display 1009 are as shown in FIG. 17A. Image B is entirely hidden behind image C. Image A is entirely hidden behind image B. Furthermore, image D is partially hidden behind image C.

Referring back to the overlapping image layer management table 500 shown in FIG. 16, a list number 501 is used to manage a list managed by the overlapping image layer management table 500. The list number 501 is an integer value, and is generated by incrementing a number from 1. A front image name 502 indicates an image behind which at least part of an image is hidden. For example, the identifier of the image is stored in the front image name 502. A rear image name 503 indicates an image at least part of which is hidden behind the image of the corresponding front image name 502. For example, the identifier of the hidden image is stored in the rear image name 503.

The state of the overlapping image layer management table 500 shown in FIG. 16 is obtained when the image management table 300 is as shown in FIG. 18. FIG. 16 shows a case in which at least part of each of images B, D, and A is positioned behind image C. FIG. 16 also shows a case in which at least part of image A is positioned behind image B.

A method of generating the overlapping image layer management table 500 will be described. The generation method will be explained by exemplifying the state of the image management table 300 shown in FIG. 18. The images are sequentially used as a reference image from an image having a higher hierarchical level by referring to the layer information 302, and then an image having a hierarchical level lower than that of the reference image and overlapping the reference image is specified by referring to the position information 303. To specify such an image, images each having a hierarchical level lower than that of the reference image are sequentially used as a test image from an image having a higher hierarchical level, and then overlapping of the range of the reference image and that of the test image is determined. If overlapping of the images is determined, the test image is hidden behind the reference image, and thus the test image can be specified as an image overlapping the reference image. If overlapping is determined and the reference image at this time is not registered in the front image name 502, a new list is added to the overlapping image layer management table 500 and assigned with a list number, and the reference image is registered in the front image name 502 of the list. The test image is registered in the rear image name 503. This operation is repeatedly performed while sequentially lowering the hierarchical level of the test image. When determination by using the image having a lowest hierarchical level as a test image is complete, the same determination processing is repeated by decreasing the hierarchical level of the reference image. This is repeated until the above processing is completed by using an image having a second lowest hierarchical level as a reference image. This procedure makes it possible to create the overlapping image layer management table 500 based on the image management table 300 although it is merely an example.

In the case of the image management table 300 shown in FIG. 18, it is determined based on the layer information 302 whether there is an image overlapping behind image C having a highest hierarchical level. More specifically, by referring to the layer information 302 and the position information 303, it is determined whether there is an image overlapped behind image C. Since images B, D, and A are hidden behind image C in the hierarchical level order, image C is registered in the front image name 502 and images B, D, and A are registered in the rear image name 503.

The same determination processing is performed for image E having a second highest hierarchical level. Since there is no image overlapped behind image E, the process ends.

The same determination processing is performed for image B having a third highest hierarchical level. Since image A overlaps image B behind it, image B is registered in the front image name 502 and image A is registered in the rear image name 503.

The same determination processing is performed up to the image having a lowest hierarchical level in the layer information 302, thereby generating the overlapping image layer management table 500.

<Processing Procedure of Displaying Image Hidden Behind Another Image in Foreground of Liquid Crystal Display 1009>

FIG. 19 is a flowchart illustrating a processing procedure of moving an image hidden behind another image to the foreground of the liquid crystal display 1009 in step S207 of the flowchart shown in FIG. 7. The CPU 1001 executes the processing procedure shown in FIG. 19 unless otherwise specified, and will thus be omitted in a description of the processing procedure.

In step S601, the overlapping image layer management table 500 described with reference to FIG. 16 is generated. The overlapping image layer management table 500 may be generated not at this timing but when an image is laid out and overlaps with another image.

In step S602, by referring to the list number 501 of the overlapping image layer management table 500, it is determined whether there is a list. If there is no list, the process ends. If it is determined in step S602 that there is a list, the process advances to step S603.

In step S603, a list including, in the front image name 502, an image at the most background level (that is, an image having a lowest hierarchical level) is selected from unselected lists of the overlapping image layer management table 500. More specifically, as is apparent from the above-described creation procedure, an image in the front image name 502 of a list having a largest list number is at the lowest hierarchical level among images in the front image names of all the lists. By referring to the list number 501 of the overlapping image layer management table 500, therefore, the images are sequentially selected from an image having a largest value of the list number 501 (an image having a lower hierarchical level of the front image name 502).

In step S604, the hierarchical levels of images in the front image name 502 and the rear image name 503 corresponding to the list number 501 selected in step S603 are updated according to a condition. More specifically, the values of the pieces of layer information 302 of the image management table 300 of the images are updated. The processing procedure in step S604 will be described in detail later.

In step S605, the list number 501 selected in step S603 is deleted and the process returns to step S602.

<Image Management Table Layer Change Procedure>

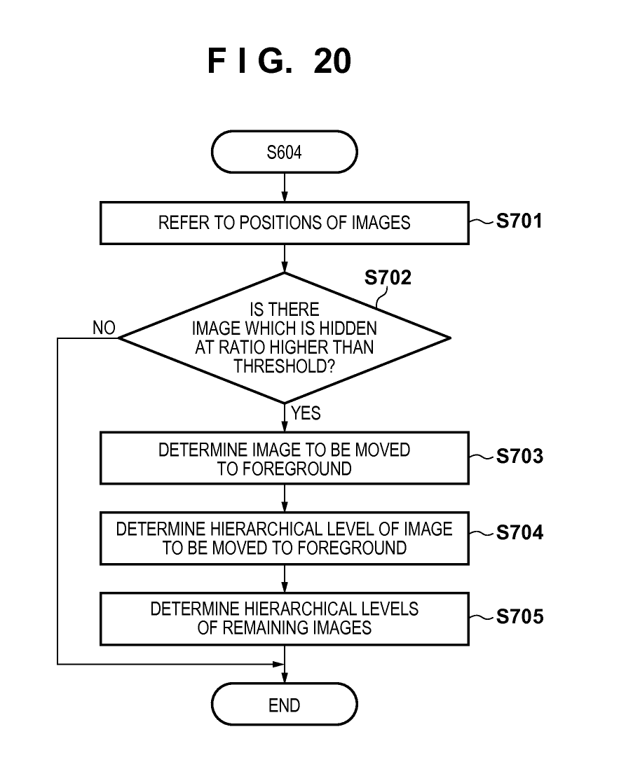

FIG. 20 is a flowchart illustrating the layer change processing in step S604 of the flowchart shown in FIG. 19. The CPU 1001 executes the processing procedure shown in FIG. 20 unless otherwise specified, and will thus be omitted in a description of the processing procedure. Note that an image in the front image name 502 will be referred to as a front image and an image in the rear image name 503 will be referred to as a rear image hereinafter.

In step S701, the positions of the front image and the rear image are referred to. In step S702, the ratio of part of the rear image hidden behind the front image to the whole rear image is calculated, and compared with a set threshold. It is then determined whether the rear image is hidden at the predetermined ratio or higher. If, for example, the set threshold is 100%, it is controlled in steps S703 to S705 to move the layer of the rear image, which is entirely hidden behind the front image, to the foreground (that is, move the layer of the rear image to a hierarchical level higher than that of the front image). If the set threshold is 70%, it is controlled in steps S703 to S705 to move the layer of the rear image which is hidden behind the front image at 70% or higher to the foreground.

If it is determined in step S702 that there is no rear image which is hidden behind the front image at the set threshold (ratio) or higher, the process ends. If it is determined in step S702 that there is a rear image which is covered by the front image at a ratio exceeding the set threshold, the process advances to step S703.

In step S703, an image whose layer is to be moved to the foreground is determined. That is, a rear image whose hierarchical level is to be changed to a hierarchical level higher than that of the front image is determined. An image whose layer is to be moved to the foreground is an image which has been determined in step S702 to be hidden behind the front image at the set ratio or higher. Therefore, there may be a plurality of images to be moved.

In step S704, the hierarchical level of the image determined in step S703 after movement is determined. As a method of determining the hierarchical level after movement, the values of the pieces of layer information 302 of the front image and rear image of the list number 501 currently processed are sequentially assigned to the images determined in step S703 from the highest hierarchical level. At this time, values are assigned to the pieces of layer information 302 of the images to be moved from the higher hierarchical level so as to maintain, even after movement, the order of the hierarchical levels before movement.

In step S705, the hierarchical levels of the remaining images of the list number 501 currently processed, which have not been determined in step S703 as images to be moved to the foreground are determined. The hierarchical levels other than those assigned to the images determined to be moved to the foreground in step S703 are assigned to the pieces of layer information 302 of the remaining images so as to maintain the order of the hierarchical levels of the remaining images before movement.

In steps S703 to S705, images which are not included in the list number 501 currently processed maintain their current hierarchical levels.

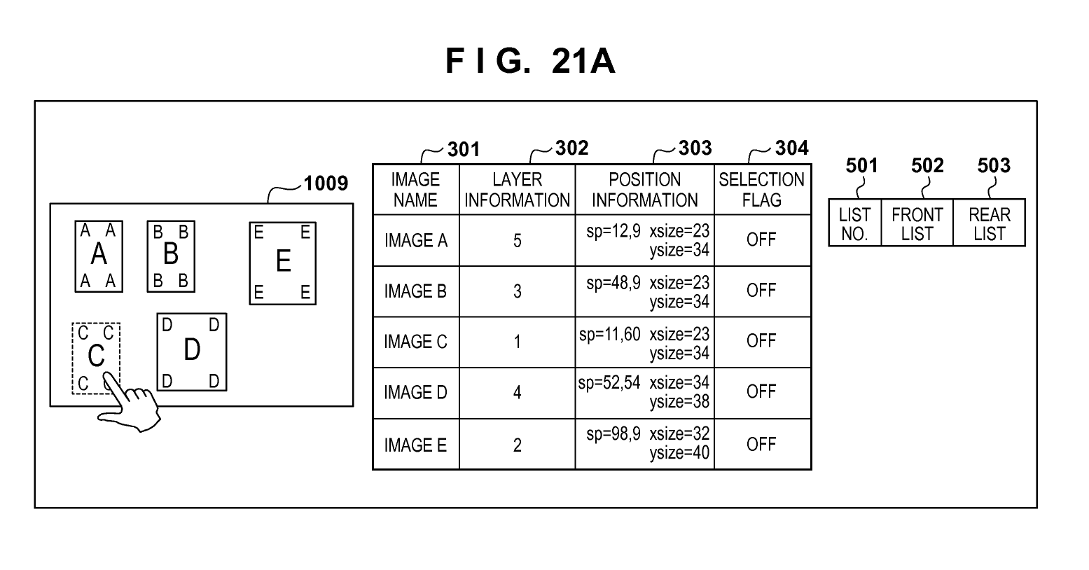

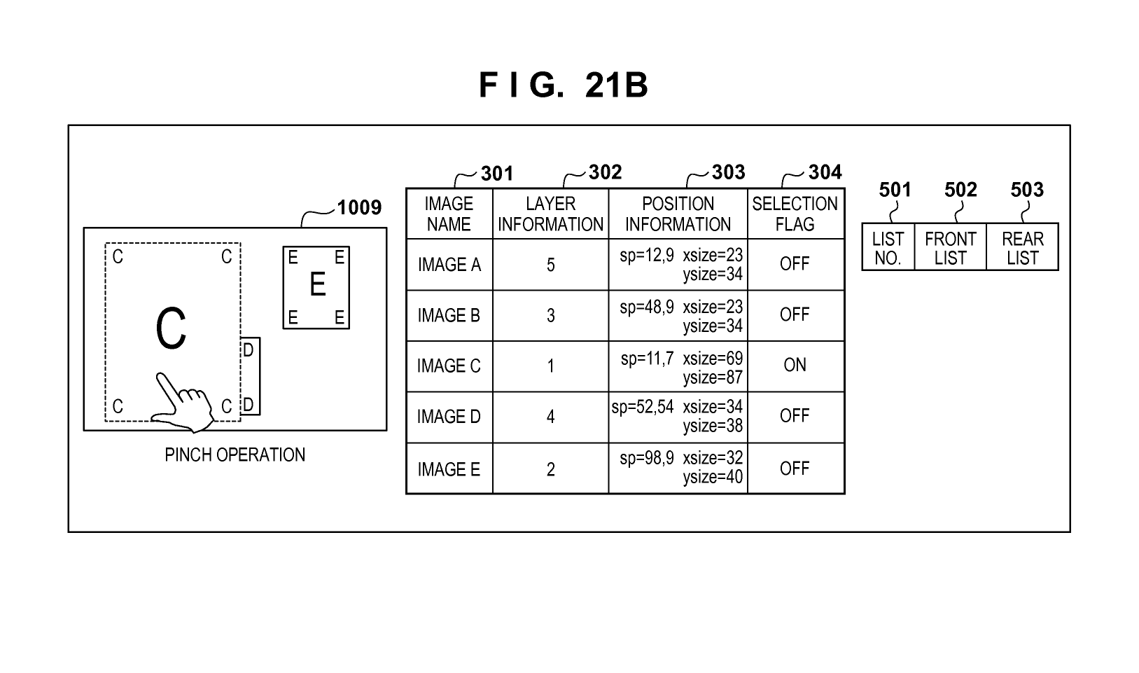

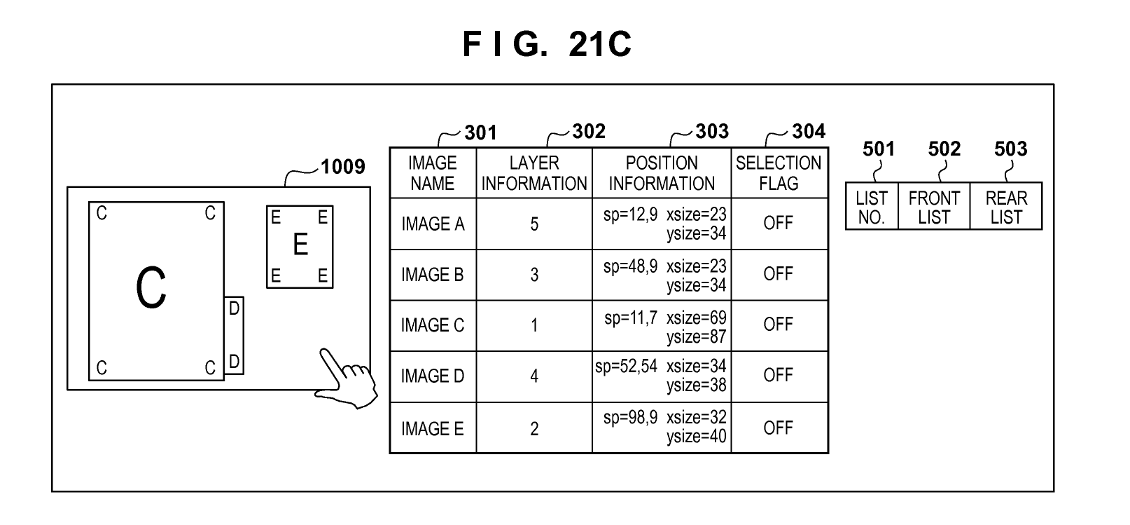

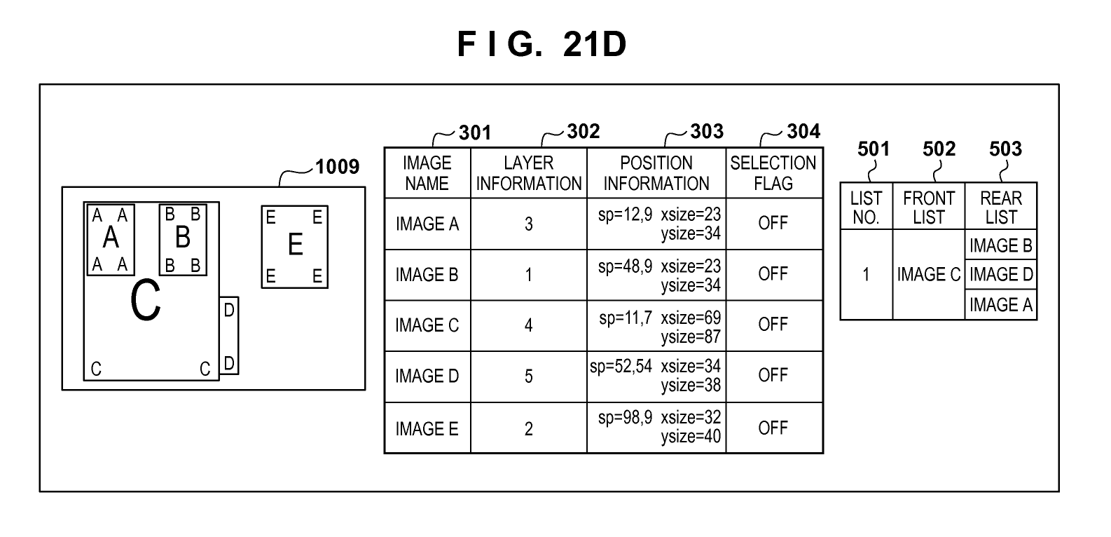

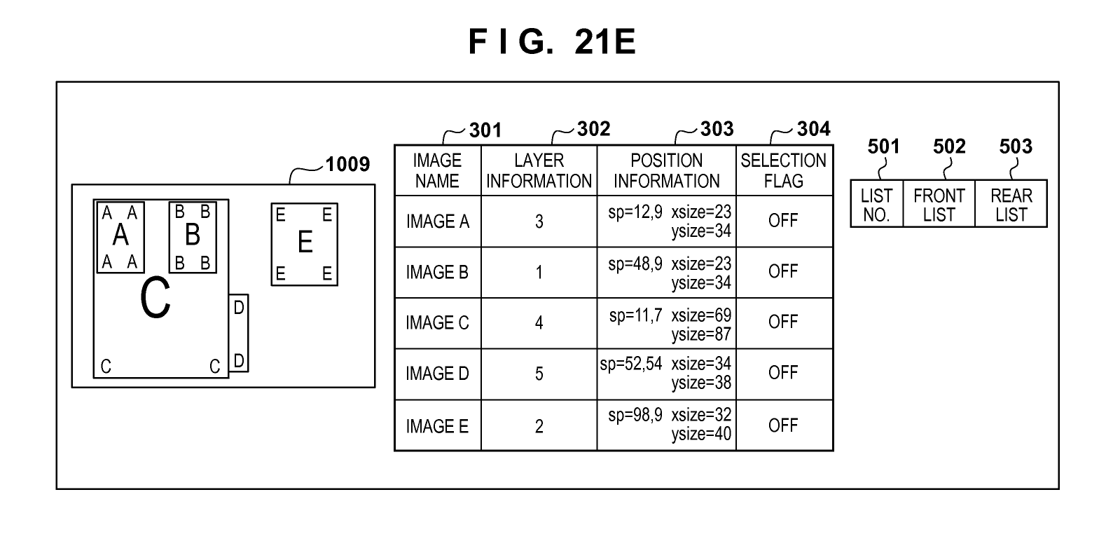

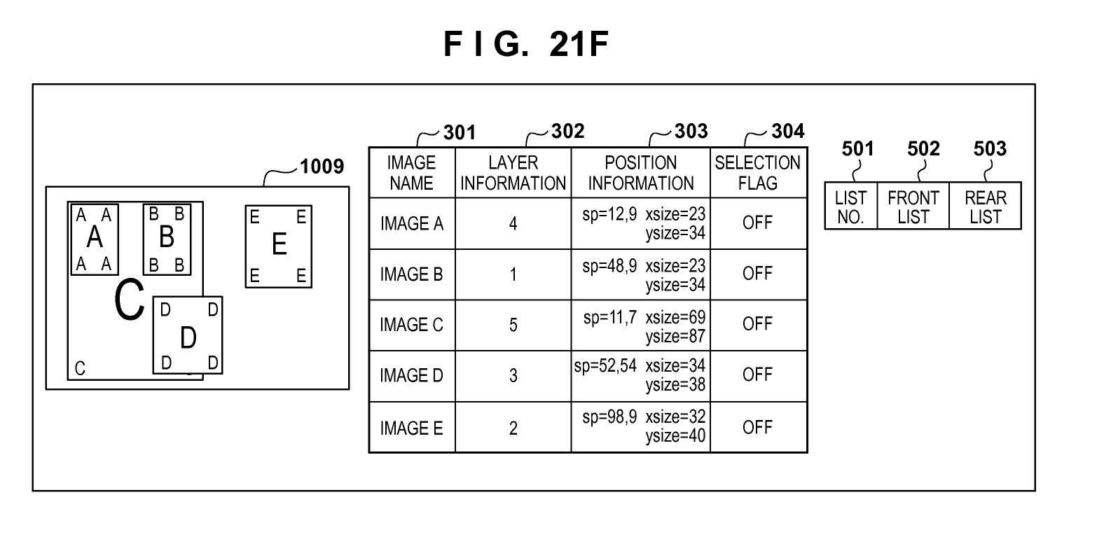

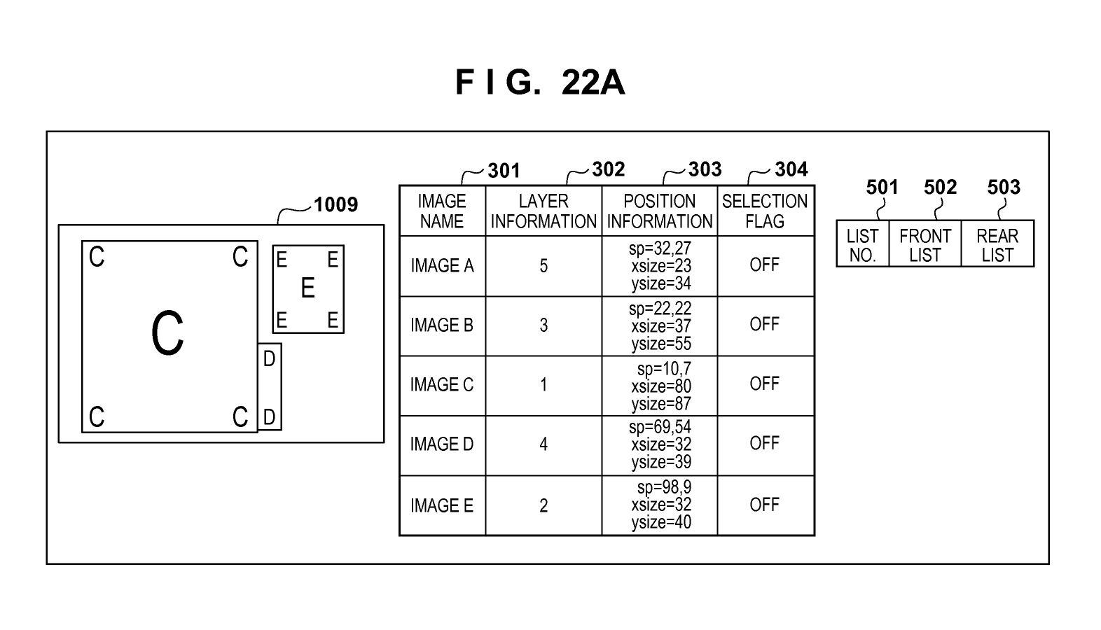

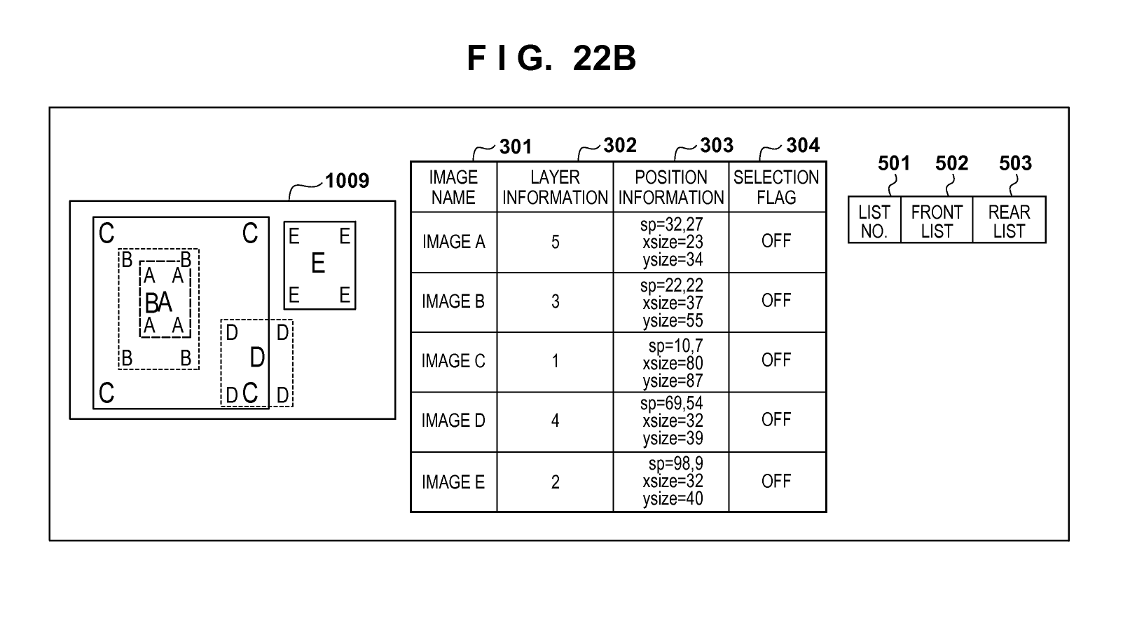

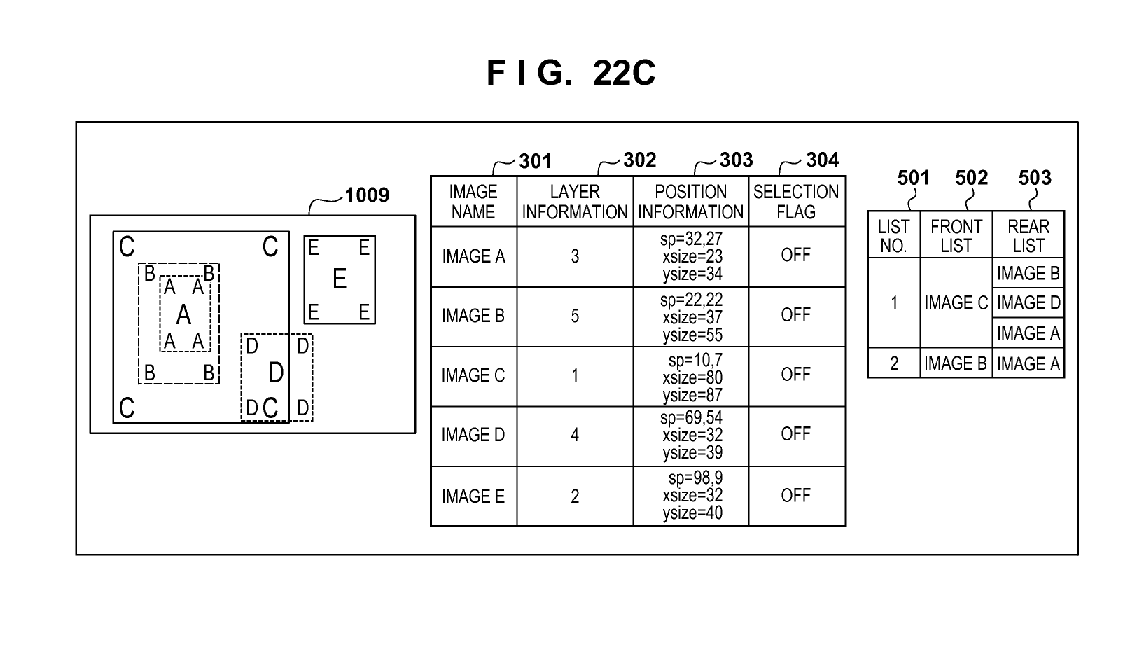

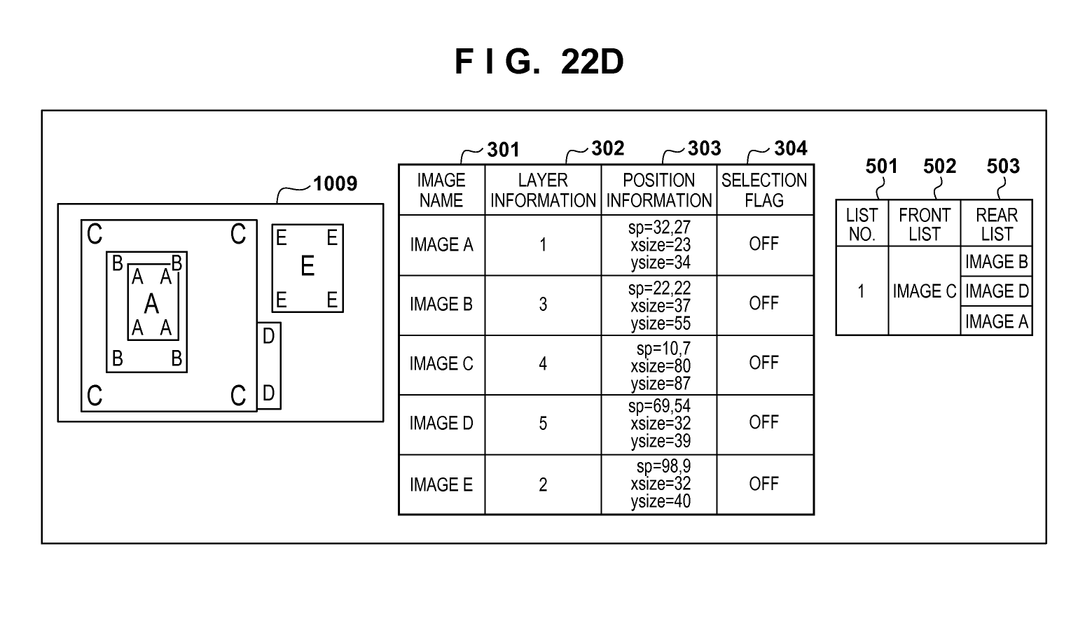

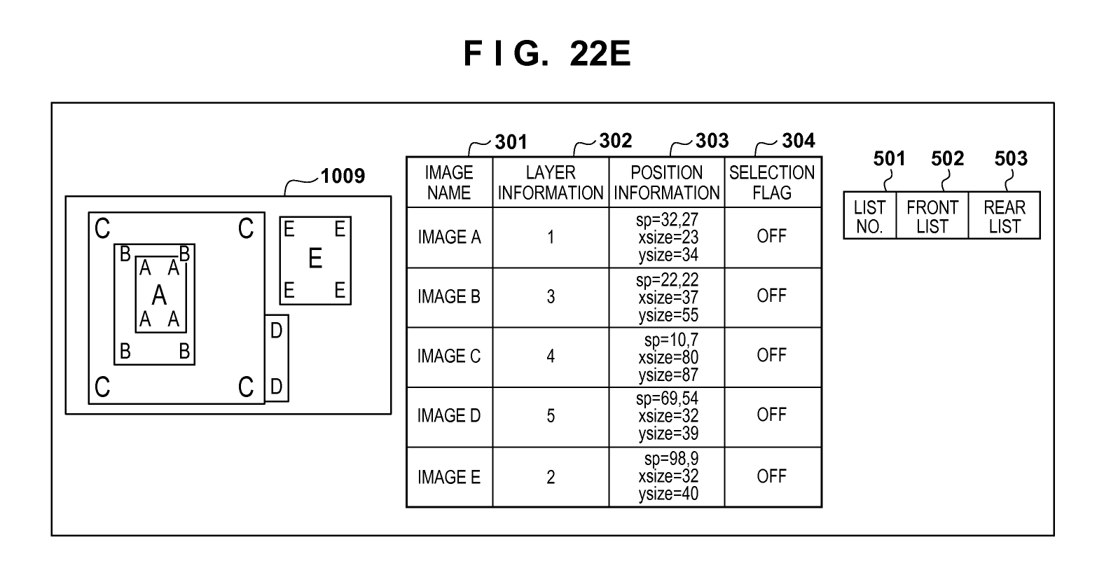

A method of updating the layer information 302 of the image management table 300 and controlling the overlapping image layer management table 500 will be described below with reference to FIGS. 21A to 21F and 22A to 22E together with a screen displayed on the liquid crystal display 1009.

<Update of Image Management Table and Overlapping Image Layer Management Table>

FIGS. 21A to 21F are views showing a method of updating and controlling the image management table 300 and the overlapping image layer management table 500 when the user double taps the second touch panel 1008 according to the procedure shown in FIG. 20. As a use case, a case in which when the user performs a layout operation to enlarge image C, and images A, B, and D are hidden behind enlarged image C, the images hidden behind image C are moved to the foreground without moving the position of image C will be described.

Each of FIGS. 21A to 21F and 22A to 22E is a view showing display of the liquid crystal display 1009 in the left portion, the state of the image management table 300 in the middle portion, and the state of the overlapping image layer management table 500 in the right portion.

FIG. 21A is a view showing a state in which image C has been selected. The overlapping image layer management table 500 is not generated.

FIG. 21B is a view showing a state in which the user has performed a pinch operation on the first touch panel 1007 to enlarge image C in the state shown in FIG. 21A. The above processing is implemented by the processing procedure in steps S101 to S106 of FIG. 5. The position information 303 of image C is updated by the position and size of image C after enlargement, as a matter of course.

Note that as indicated by the layer information 302, image C has the highest hierarchical level “1” among the five images, and images A, B, and D are hidden behind image C.

FIG. 21C is a view showing a state in which the user has single tapped a position where no image is displayed on the first touch panel 1007 to cancel the selection of the image in the state shown in FIG. 21B. In this state, the overlapping image layer management table 500 is not generated.

FIGS. 21D to 21F are views each showing the state of the image management table 300 and the overlapping image layer management table 500 when the processing shown in FIG. 20 is performed. FIGS. 21D and 21E are views for explaining a case in which the set ratio used for determination in step S702 of FIG. 20 is 100%. FIG. 21F is a view for explaining a case in which the set ratio used for determination in step S702 of FIG. 20 is 70%.

FIG. 21D is a view showing a state in which the user has double tapped the second touch panel 1008 in the state shown in FIG. 21C. This operation causes the CPU 1001 to generate an overlapping image layer management table 500 in step S601 of FIG. 19 (FIG. 21D). After that, the CPU 1001 determines in step S602 that the overlapping image layer management table 500 includes a list. In step S603, the CPU 1001 selects a list in which the hierarchical level of a corresponding front image is lowest. In this example, the list number 501 includes only one list, and thus the list number 501 of “1” is selected. In step S604 in which the processing in steps S701 to S704 is performed, the layer change processing is performed.

In step S701 of FIG. 20, the CPU 1001 refers to the positions of image C as a front image and images B, D, and A as rear images. In step S702, the CPU 1001 determines that images A and B are hidden behind image C at a ratio equal to or higher than the threshold, and the process advances to step S703.

In step S703, the CPU 1001 determines images A and B as images to be moved to the foreground.

In step S704, the CPU 1001 refers to the pieces of layer information 302 of image C as a front image and images B, D, and A as rear images (the pieces of layer information 302 shown in FIG. 21C). The values of the pieces of layer information 302 of the four images are “1”, “3”, “4”, and “5”, respectively. To move images A and B to the foreground, therefore, according to the order of the hierarchical levels of the images before movement, “1” is assigned to the layer information 302 of image B and “3” is assigned to the layer information 302 of image A. Since image B has a hierarchical level higher than that of image A in the state shown in FIG. 21C, “1” is assigned to image B.

In step S705, among the remaining hierarchical levels “4” and “5”, the CPU 1001 assigns “4” to the layer information 302 of image C and “5” to the layer information 302 of image D so as to maintain the order of the hierarchical levels of the images before movement. Since image C has a hierarchical level higher than that of image D in the state shown in FIG. 21C, the CPU 1001 assigns “4” to image C.

FIG. 21E is a view showing a state in which the list number 501 of “1” currently processed is deleted from the overlapping image layer management table 500 in step S605 of FIG. 19.

FIG. 21F is a view showing another case in which the user double taps the second touch panel 1008 in the state shown in FIG. 21C. The difference from FIG. 21E is that the ratio set as the threshold used for determination in step S702 of FIG. 20 is 70%. Therefore, image D is also an image to be moved to the foreground. A processing procedure is the same as that described with reference to FIG. 21D and a description thereof will be omitted. FIG. 21F shows only the final result.

FIGS. 22A to 22E are views showing a method of updating and controlling the image management table 300 and the overlapping image layer management table 500 when the user double taps the second touch panel 1008, similarly to FIGS. 21A to 21F.

FIGS. 22A to 22E are the same as FIG. 21A in that images A, B, and D are hidden behind image C but are different from FIG. 21A in that image A is also hidden behind image B. A case in which the set ratio used for determination in step S702 of FIG. 20 is 100% will be exemplified below.

FIG. 22A is a view showing a state in which no image is currently selected. In this state, the overlapping image layer management table 500 is not generated.

FIG. 22B shows, on the liquid crystal display 1009, the hierarchical levels and positions of the respective images by transparentizing the images shown in FIG. 22A. FIG. 22B shows the fact that images B and D indicated by fine dotted lines are hidden behind image C. FIG. 22B shows the fact that image A indicated by rough dotted lines is hidden behind image C and is also hidden behind image B. The state of the image management table 300 and the overlapping image layer management table 500 in FIG. 22A is the same as that in FIG. 22B, as a matter of course.

FIGS. 22C to 22E are views each showing a state in which the user has double tapped the second touch panel 1008 in the state shown in FIG. 22A. The CPU 1001 generates an overlapping image layer management table 500 in step S601 of FIG. 19. Unlike FIGS. 21A to 21F, there is also a list representing the overlapping relationship between images A and B, and thus a second list number 501 is generated. The CPU 1001 determines in step S602 that there are lists. In step S603, the CPU 1001 selects a front list of the most background level. In this example, among the list numbers 501, the CPU 1001 selects the list number 501 of “2” of the most background level. In step S604, the CPU 1001 executes layer change processing for images A and B, thereby updating the pieces of layer information 302 of images A and B.

FIG. 22D shows a state in which the layer change processing in step S604 of FIG. 19 is complete in FIG. 22C, and the layers of images A and B have been switched. The CPU 1001 deletes the list number 501 of “2” currently processed from the overlapping image layer management table 500 in step S605 of FIG. 19. The CPU 1001 then returns the process to step S602 to check again that there is a list. In this example, since there is the list having the list number 501 of “1”, the CPU 1001 executes the processing in steps S603 and S604 of FIG. 19 for the list having the list number “1”. As a result, the image management table 300 and the images displayed on the liquid crystal display 1009 are updated as shown in FIG. 22D. After the update operation, images A and B are selected, and their layers are moved to hierarchical levels higher than that of image C while maintaining the order of the hierarchical levels of the images.

FIG. 22E is a view showing a state in which the list having the list number 501 of “1” currently processed has been deleted from the overlapping image layer management table 500 in step S605 of FIG. 19.

As described above, immediately after the user enlarges image C by a pinch operation, it is possible to move a hidden image to the foreground by moving image C to the most background level. If, however, the user performs various layout processes and an image is hidden behind another image without the knowledge of the user, he/she cannot identify the hidden image in some cases. In this case, an image in the foreground (that is, an image having a higher hierarchical level) may have to be moved to the background many times in the operation and processing in step S203, S204, or S206 of FIG. 7. In such case, the procedure shown in FIG. 19 is effective.

According to the above-described embodiment, it is possible to change the hierarchical level of an image by a layer movement operation independent of an image selection operation in an image layout system in which a unique hierarchical level is assigned to each image and the images are displayed according to priority levels corresponding to the hierarchical levels. It is also possible to explicitly or implicitly select an image whose hierarchical level is to be changed. The hierarchical level can be raised or lowered. Furthermore, by using, as a device used for a layout operation, a touch panel corresponding to the rear surface of an image in addition to a touch panel corresponding to the front surface of the image, it is possible to readily and intuitively change the hierarchical level of the image, thereby significantly improving the operability.

According to the above-described embodiment, it is possible to apply the present invention to even an information processing apparatus without a pressure sensor as long as it includes a touch sensor.

Note that the system which allows all the layer movement operations described in steps S203, S204, S206, and S207 of FIG. 7 has been explained. For example, however, it is possible to implement a system for implementing only the processes in steps S203 and S204 in which the hierarchical level of the selected image is changed, a system for implementing only the process in step S206 which is feasible on only the first touch panel, or a system for implementing only the process in step S207 which is feasible on only the second touch panel. It is also possible to implement a system formed by an arbitrary combination of the above functions. Since the second touch panel is not used to input coordinates in the above embodiment, it is sufficient to provide a device which can detect a touch without detecting its position, more desirably, a device which can detect a multi-touch operation.

In the aforementioned example, based on the analogy of an operation of “pressing” an image, the first touch panel on the front surface is assigned to an operation of lowering a hierarchical level and the second touch panel on the rear surface is assigned to an operation of raising a hierarchical level, and vice versa. That is, one touch panel is assigned to an operation of raising a hierarchical level and the other touch panel is assigned to an operation of lowering a hierarchical level.

The touch panel used in the aforementioned embodiment can be replaced by another device for inputting coordinates. In addition to a general touch panel of an electrostatic capacitance type or resistive film type, device which uses a surface acoustic wave to input coordinates by a pen that intermittently generates an ultrasonic vibration, a device which uses electromagnetic induction, or the like may be used. Furthermore, since the aforementioned embodiment can be implemented as long as the coordinate system for display and that for input coincide with each other, it can be implemented by, for example, a personal computer including a coordinate input apparatus such as a mouse or touch pad. In a personal computer including a touch panel, the second touch panel on the rear surface is not used to select an image, and thus a touch pad provided on a keyboard or the like can be used instead of the second touch panel.

### Other Embodiments

Aspects of the present invention can also be realized by a computer of a system or apparatus (or devices such as a CPU or MPU) that reads out and executes a program recorded on a memory device to perform the functions of the above-described embodiment(s), and by a method, the steps of which are performed by a computer of a system or apparatus by, for example, reading out and executing a program recorded on a memory device to perform the functions of the above-described embodiment(s). For this purpose, the program is provided to the computer for example via a network or from a recording medium of various types serving as the memory device (for example, computer-readable medium).

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2012-269782, filed Dec. 10, 2012, which is hereby incorporated by reference herein in its entirety.

What is claimed is:

1. An information processing apparatus comprising:
a display unit configured to display an image;
a coordinate input unit having a coordinate system common to a display surface of the display unit;
a holding unit configured to hold hierarchical levels of image objects displayed by the display unit; and
a layer change unit configured to update the hierarchical levels held in the holding unit so as to lower the hierarchical level of a designated image object according to an operation via the coordinate input unit,
wherein the display unit displays the image objects according to the hierarchical levels updated by the layer change unit.

2. The apparatus according to claim 1, wherein the layer change unit sets, as the designated image object, an image object at a position where an operation of lowering a hierarchical level is performed by the coordinate input unit, and lowers the layer of the image object.

3. The apparatus according to claim 1, further comprising
a selection unit configured to select at least one of the image objects displayed by the display unit according to the operation of the coordinate input unit,
wherein the layer change unit sets, as the designated image object, the image object selected by the selection unit, and lowers the layer of the image object.

4. The apparatus according to claim 3, further comprising
a second input unit configured to perform an input operation according to a user operation,
wherein the layer change unit updates the hierarchical levels held in the holding unit to raise the hierarchical level of the image object selected by the selection unit according to an operation via the second input unit.

5. The apparatus according to claim 1, wherein the layer change unit changes the hierarchical level of the designated image object by one.

6. The apparatus according to claim 1, wherein
the coordinate input unit is capable of simultaneously detecting operations at a plurality of positions, and
the layer change unit changes the hierarchical level of the designated image object by the number of hierarchical levels according to the number of positions where operations are simultaneously input via the coordinate input unit.

7. The apparatus according to claim 1, wherein the layer change unit lowers, if the operation has been input via the coordinate input unit, the hierarchical level of the designated image object to a lowest one of the hierarchical levels held in the holding unit, and raises, if the operation has been input via the second input unit, the hierarchical level of the designated image object to a highest one of the hierarchical levels held in the holding unit.

8. The apparatus according to claim 4, wherein if no image object is selected by the selection unit, the layer change unit updates the hierarchical levels held in the holding unit to raise a hierarchical level of an image object having a lowest hierarchical level among overlapping image objects to a highest one of hierarchical levels of the overlapping image objects.

9. An information processing apparatus comprising:
a display unit configured to display an image;
an input unit configured to perform an input operation according to a user operation;
a holding unit configured to hold hierarchical levels of image objects displayed by the display unit; and
a layer change unit configured to update the hierarchical levels held in the holding unit so as to raise the hierarchical level of an image object having a lowest hierarchical level among overlapping image objects to a highest one of hierarchical levels of the overlapping image objects,
wherein the display unit displays the image objects according to the hierarchical levels updated by the layer change unit.

10. An information processing apparatus comprising:
a first touch screen for displaying a plurality of image objects;
a second touch screen;
a specification unit configured to specify one of the plurality image objects displayed on the first touch screen in response to a user touch operation via the first touch screen; and
a processing unit configured to perform a predetermined process on the specified image object in response to a user touch operation via the second touch screen.

11. The apparatus according to claim 10, wherein if there is an image object explicitly selected via the first touch screen, the specified image object is the selected image object, if an operation of lowering a hierarchical level has been performed via the first touch screen and no image object has been explicitly selected, the specified image object is an image object at a position where the operation of lowering the hierarchical level is performed via the first touch screen, or if an operation of raising a hierarchical level has been performed via the second touch screen and no image object has been explicitly selected, the specified image object is an image object having a lowest one of hierarchical levels of overlapping image objects.

12. The apparatus according to claim 10, wherein the second touch screen is arranged to face the first touch screen on a rear surface of the first touch screen.
